(19) United States
(12) Patent Application Publication
(10) Pub. No.: US 2024/0272906 A1
(43) Pub. Date: Aug. 15, 2024

(54) SUBROUTINE OBJECTS FOR WORKFLOW IMPLEMENTATION

(71) Applicant: Ramp Business Corporation, New York, NY (US)

(72) Inventors: Rodda John, New York, NY (US); Pavel Asparouhov, New York, NY (US); Veeral Dilip Patel, New York, NY (US); Bertrand Janin, New York, NY (US); Nikolay Koblov, New York, NY (US)

(21) Appl. No.: 18/204,286

(22) Filed: May 31, 2023

Related U.S. Application Data
(60) Provisional application No. 63/483,974, filed on Feb. 9, 2023.

(51) Int. Cl. G06F 9/30; G06F 9/46

(52) U.S. Cl. CPC G06F 9/3005; G06F 9/466

(57) ABSTRACT

A computing server may store a plurality of machine-code subroutine objects. The computing server may receive a definition of a policy. The computing server may identify a plurality of components in the policy based on the definition. The computing server may determine, for each component in the plurality of components of the policy, a corresponding subroutine that needs to be executed to fulfill the component. The computing server may identify, for each component in the plurality of components of the policy, a corresponding machine-code subroutine object that includes the instructions to execute the corresponding subroutine. The computing server may generate a syntax tree to represent an executable workflow that implements the policy. The syntax tree may connect the identified machine-code subroutine objects that correspond to the subroutines that need to be executed to fulfill the components of the policy. The computing server may associate the syntax tree with the policy.

### CROSS REFERENCE TO RELATED APPLICATION

This application claims the benefit of U.S. Provisional Application No. 63/483,974, filed on Feb. 9, 2023, which is incorporated by reference herein for all purposes.

### TECHNICAL FIELD

The present disclosure generally relates to subroutine management, and more specifically to storing subroutine objects as building blocks of workflows.

### BACKGROUND

A server nowadays often handles thousands of requests per minute. Transactions and communications among devices sometimes require a server's authentication and approval before the transactions can be completed. On one hand, to reduce the delay associated with transactions, a communication protocol may be associated with rather stringent specifications that may require a server to respond within a short time frame. On the other hand, the wealth of data, especially big data, often makes locating and retrieving relevant data a complex process that could slow down a server. Parties in transactions also demand flexibility and customizability of transactions, making processing a transaction even more demanding. Even a state-of-the-art server could have difficulties in meeting the timing requirements in a transaction approval process.

The issue is particularly challenging when a system is not originally designed to perform certain functionalities. For example, participants in the system often add customized features to the system in a non-standardized way. Data communication may not have a standard protocol or format, leading to various implementations of policy based on the system environment and underlying programming formats. A server may apply complex rules in analyzing the received data associated with a transaction, but any such policy enforcement inevitably may have scaling issues, especially for a platform that serves various organization customers that may have very different policy requirements.

### SUMMARY

Embodiments are related to a computer-implemented method, including: storing a plurality of machine-code subroutine objects, each machine-code subroutine object including instructions for a subroutine that is executable; receiving a definition of a policy: identifying a plurality of components in the policy based on the definition: determining, for each component in the plurality of components of the policy, a corresponding subroutine that needs to be executed to fulfill the component: identifying, for each component in the plurality of components of the policy, a corresponding machine-code subroutine object that includes the instructions to execute the corresponding subroutine: generating a machine-code syntax tree to represent an executable workflow that implements the policy, the machine-code syntax tree connecting a plurality of identified machine-code subroutine objects that correspond to the subroutines that need to be executed to fulfill the components of the policy; and associating the machine-code syntax tree with the policy.

In some embodiments, the machine-code syntax tree includes the plurality of identified machine-code subroutine objects that are represented as vertices and the vertices are connected to form the executable workflow in one or more orders.

In some embodiments, the computer-implemented method may further include receiving a transaction request: determining that the transaction request is subject to the policy; and executing the machine-code syntax tree to determine whether the transaction request is compliant with the policy.

In some embodiments, storing the plurality of machine-code subroutine objects includes storing an action subroutine object, the action subroutine object defining a particular subroutine that includes one or more actions to be performed to complete the particular subroutine.

In some embodiments, storing the plurality of machine-code subroutine objects includes storing a condition subroutine object, the condition subroutine object defining a particular subroutine that includes one or more conditions to be checked to complete the particular subroutine.

In some embodiments, receiving the definition of the policy includes: providing a list of candidate actions and/or conditions for a domain, each action or condition corresponding to a machine-code subroutine object that is stored: receiving, from the domain, a selection of actions and/or conditions to define the policy, wherein a selected action or condition corresponds to a component of the policy, and wherein generating the machine-code syntax tree includes: selecting a set of machine-code subroutine objects that correspond to the selection of actions and/or conditions that define the policy.

In some embodiments, the machine-code syntax tree is a first machine-code syntax tree that is associated with a first policy of a first domain, and the computer-implemented method further includes associating a second machine-code syntax tree with a second policy of a second domain that is different from the first domain.

In some embodiments, storing the plurality of machine-code subroutine objects is performed by a computing server that provides a software-as-a-service (SaaS) platform to a plurality of domain customers, and the first machine-code syntax tree and the second machine-code syntax tree that are associated with different domain customers share one or more machine-code subroutine objects that are stored by the computing server.

In some embodiments, the computer-implemented method may further include receiving a modification of the policy: modifying the machine-code syntax tree, wherein modifying the machine-code syntax tree includes inserting a machine-code subroutine object to the machine-code syntax tree or removing a machine-code subroutine object from the machine-code syntax tree; and storing a modified machine-code syntax tree as a modified workflow that implemented the policy as modified.

In some embodiments, the computer-implemented method may further include executing the machine-code syntax tree, wherein executing the machine-code syntax tree includes: executing a first set of machine-code instructions to communicate to a named entity for an authorization request; and executing a second set of machine-code instructions to compare a response of the authorization request to a condition defined in one of machine-code subroutine objects in the machine-code syntax tree.

In some embodiments, storing the plurality of machine-code subroutine objects includes: generating parameters and executable routines of a subroutine function in a source code format: compiling the subroutine function into binary instructions as one of the machine-code subroutine objects; and storing the one of the machine-code subroutine objects in a data store, wherein the one of the machine-code subroutine objects is available as a component of one or more policies.

In some embodiments, the techniques described herein relate to a computer-implemented method including: creating, on behalf of a domain and by an ontology management operator, a first data object that represents an account, wherein the domain delegates transaction authorization of one or more transactions of the domain to the ontology management operator: providing a graphical user interface for the domain to define a domain specific policy that is part of a domain knowledge ontology of the domain: storing the domain specific policy as a second data object: receiving, from the domain, an assignment that assigns the domain specific policy to the account: connecting, responsive to the domain assigning the domain specific policy to the account, the first data object and the second data object: receiving an authorization request for a transaction associated with the account; identifying, from the domain knowledge ontology of the domain, a chain of data objects that is relevant to completing the authorization request for the transaction, the chain of data objects includes the first data and the second data object: defining a workflow to authorize the transaction through traversing the chain of data objects: identifying a violation in the transaction of a condition in the workflow, the violation preventing the workflow from being completed, the condition being defined in the domain specific policy: identifying a third data object in the chain of data objects that is associated with the condition, the third data object representing a named entity; and transmitting a notification to the named entity to add an adjustment, wherein the adjustment is added to the domain knowledge ontology that authorizes a future transaction that violates the condition.

In some embodiments, the second data object storing the domain specific policy is assigned to a plurality of accounts, and wherein the fourth data object is added to the chain of data objects that is specific to the account that is represented by the first data object without changing the second data object.

In some embodiments, one of the data objects in the chain of data objects represents one of the following: a named entity within the domain, a third party named entity, a domain department, a policy, a documentation, or a version.

In some embodiments, the domain specific policy governs a total amount combined from a type of real-time transaction and a type of non-real-time transaction.

In some embodiments, the chain of data objects includes a post-transaction requirement and one or more features of the account is suspended if the post-transaction requirement is not met.

In some embodiments, the domain specific policy includes a combination of one or more of following conditions: amount specific condition, merchant category code condition, employee level condition, or time condition.

In some embodiments, a particular data object in chain of data objects is linked to a third party platform and the particular data object specifies a second condition that automatically transmits data to the third party platform.

In some embodiments, the computer-implemented method may further include generating a recommendation to the account on seeking approval of the transaction.

In some embodiments, the recommendation is a second workflow that is presented to the account for the account to seek approval of the transaction.

### BRIEF DESCRIPTION OF THE DRAWINGS

FIG. 1 is a block diagram illustrating an example system environment, in accordance with some embodiments.

FIG. 2 includes block diagrams illustrating components of an example policy management server and an example authorizer server, in accordance with some embodiments.

FIG. 3 is a conceptual diagram illustrating an example structure of data objects that represent a domain knowledge ontology of a domain maintained by the ontology management operator, in accordance with some embodiments.

FIG. 4 is a flowchart depicting a computer-implemented process for defining a transaction approval workflow based on a domain-specific policy, in accordance with some embodiments.

FIG. 5A through FIG. 5D are conceptual diagrams illustrating a graphical representation of part of the domain knowledge ontology of a domain that includes various relationships among different concepts and things stored as data objects, in accordance with some embodiments.

FIG. 6 is a conceptual diagram of a structure of an example neural network, in accordance with some embodiments.

FIG. 7 is a flowchart depicting a computer-implemented process 700 for defining a syntax tree that defines a workflow for implementing a policy, in accordance with some embodiments.

FIG. 8A is a conceptual diagram illustrating two example types of subroutine objects, in accordance with some embodiments.

FIG. 8B is a conceptual diagram illustrating an example syntax tree that defines a workflow for implementing a policy, in accordance with some embodiments.

FIG. 9 is a conceptual diagram of a GUI that allows a customer of the computing server to define a card restriction policy for transactions, in accordance with some embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

In some embodiments, a computing server may serve as a platform for different organizations to delegate one or more transactions and tasks to the computing server and for the computing server to enforce one or more policies that govern the transactions. Because of factors and system environments that are different among various organizations that are unrelated, it is often challenging for the computing server to enforce policies in an effective manner. In some embodiments, the computing server may store a number of subroutine objects that are executable to carry out actions or check conditions. The subroutine objects may be stored in a format that is agnostic to an individual organization's programming environment, such as in a binary machine-code format. Those stored subroutine objects may be used as building blocks for constructing customized workflows for various organizations. An organization customer of the computing server may define a policy. The computing server connects the subroutine objects as a syntax tree that is used to implement a workflow for enforcing the policy. By using workflow and subroutine objects that are reusable in different workflows, various custom policies may be implemented in a highly scalable fashion.

### System Overview

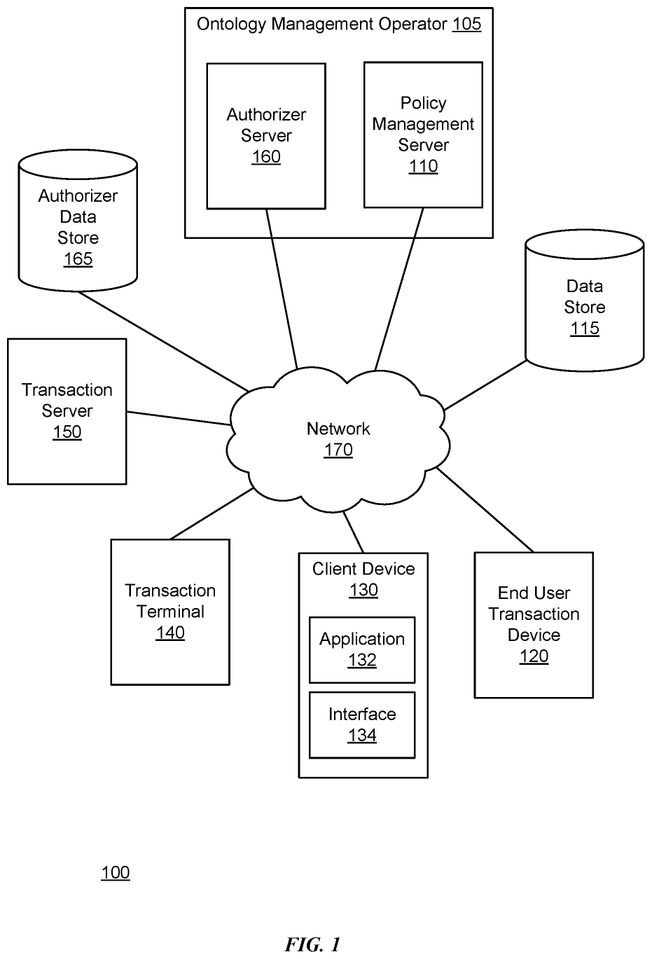

FIG. 1 is a block diagram that illustrates a spending system management environment 100, in accordance with some embodiments. The system environment 100 includes an ontology management operator 105, a policy management server 110, a data store 115, an end user transaction device 120, a client device 130, a transaction terminal 140, a transaction server 150, an authorizer server 160, and an authorizer data store 165. The entities and components in the system environment 110 communicate with each other through network 170. In various embodiments, the system environment 100 includes fewer or additional components. In some embodiments, the system environment 100 also includes different components. While each of the components in the system environment 100 is described in a singular form, the system environment 100 may include one or more of each of the components. For example, in many situations, the policy management server 110 can issue multiple end user transaction devices 120 for different end users. Different client devices 130 may also access the policy management server 110 simultaneously.

The ontology management operator 105 may be a business that provides services to various domains on managing transactions on behalf of the domains. For example, a domain customer may delegate transaction authorization of one or more transactions of the domain to the ontology management operator 105. The domain may create one or more transaction accounts with the ontology management operator 105 and the ontology management operator 105 monitors and approves transactions related to those accounts on behalf of the domain based on policies that are specified by the domain. The ontology management operator 105 may operate one or more servers, such as the policy management server 110 and the authorizer server 160 in helping the customer domains to manage transactions. Depending on embodiments, the features and functionalities of the policy management server 110 and the authorizer server 160 may be combined as a single type of server or may be separately operated as illustrated in the system environment 100. The ontology management operator 105 may also be referred to as a computing server.

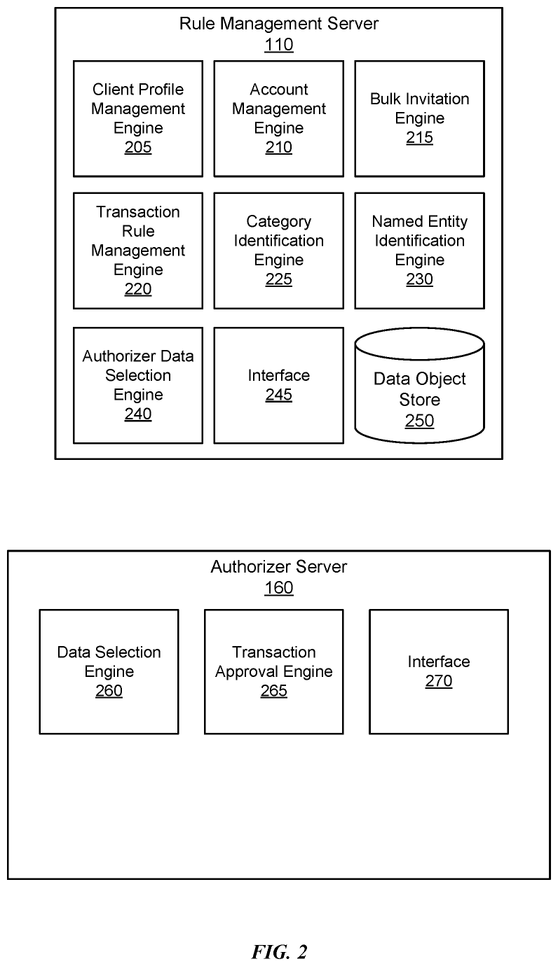

The policy management server 110 includes one or more computers that perform various tasks related to managing the policies of various clients. The policy management server 110 may also be delegated by the clients to manage the clients' accounting, payments, and transactions. For example, the policy management server 110 may create transaction accounts (e.g., credit cards, debit cards, and payment, reimbursement, or transaction-related accounts) for an organization client and manages transactions of the transaction accounts of the organization client based on policies set by the client. The policies may include pre-authorization policies, restrictions on certain transactions, and post-transaction requirements such as reporting requirements. In some embodiments, the policy management server 110 provides its clients with various payment and spending management services as a form of cloud-based software, such as software as a service (SaaS). Examples of components and functionalities of the policy management server 110 are discussed in further detail below with reference to FIG. 2. The policy management server 110 may also be referred to as a payment management server, a rule management server, a data object management server, a first computing server, or simply a computing server. The policy management server 110 may provide a SaaS platform, such as in the form of a client portal, for various clients to manage their policies related to the accounts. While transaction policies are used as primary examples in this disclosure, policies can be of any nature and are not limited to transactions.

The data store 115 includes one or more computing devices that include memory or other storage media for storing various files and data of the policy management server 110. The data stored in the data store 115 may include various policy-related data objects, accounting information, transaction data, card profiles, card policies and restrictions, merchant profiles, merchant identification rules, spending records, and other related data associated with various clients of the policy management server 110. In various embodiments, the data store 115 may take different forms. In some embodiments, the data store 115 is part of the policy management server 110. For example, the data store 115 is part of the local storage (e.g., hard drive, memory card, data server room) of the policy management server 110. In some embodiments, the data store 115 is a network-based storage server (e.g., a cloud server). The data store 115 may be a third-party storage system such as AMAZON AWS, DROPBOX, RACKSPACE CLOUD FILES, AZURE BLOB STORAGE, GOOGLE CLOUD STORAGE, etc. The data in the data store 115 may be structured in different database formats such as a relational database using the structured query language (SQL) or other data structures such as a non-relational format, a key-value store, a graph structure, a linked list, an object storage, a resource description framework (RDF), etc. In some embodiments, the data store 115 uses various data structures mentioned above.

An end user transaction device 120 is a device that enables the holder of the device 120 to perform a transaction with a party, such as making a payment to a merchant for goods and services based on information and credentials stored in the end user transaction device 120. An end user transaction device 120 may also be referred to as an end user payment device. Examples of end user transaction devices 120 include payment cards such as credit cards, debit cards, and prepaid cards, other smart cards with chips such as radio frequency identification (RFID) chips, portable electronic devices such as smartphones that enable payment methods such as virtual credit cards, APPLE PAY or GOOGLE PAY, and wearable electronic devices. The policy management server 110 issues end user transaction devices 120 such as credit cards for its organizational clients and may impose spending control policies and restrictions on those cards. While credit cards are often used as examples in the discussion of this disclosure, various architectures and processes described herein may also be applied to other types of end user transaction devices 120.

A client device 130 is a computing device that belongs to a client of the ontology management operator 105. A client uses the client device 130 to communicate with the policy management server 110 and performs various transaction management-related tasks such as creating transaction cards and associated transaction accounts, setting transaction policies such as restrictions on cards, setting pre-authorized or prohibited merchants or merchant categories, and managing transactions and records. The user of the client device 130 may be a manager, an accounting administrator, or a general employee of a domain. While in this disclosure a client is often described as an organization, a client may also be a natural person or a robotic agent. A client may be referred to a domain, an organization or its representative such as its employee. A client device 130 includes one or more applications 132 and an interfaces 114 that may display visual elements of the applications 132. The client device 130 may be any computing device. Examples of such client devices 130 include personal computers (PC), desktop computers, laptop computers, tablets (e.g., iPADs), smartphones, wearable electronic devices such as smartwatches, or any other suitable electronic devices.

In some embodiments, the client device 130 and the end user transaction device 120 belong to the same domain. For example, a company client can request the policy management server 110 to issue multiple company transaction cards for the employees. A domain refers to an environment for a group of units and individuals to operate and to use domain knowledge to organize activities, information and entities related to the domain in a specific way. An example of a domain is an organization, such as a business, an institute, or a subpart thereof and the data within it. A domain can be associated with a specific domain knowledge ontology, which could include representations, naming, definitions of categories, properties, logics, and relationships among various concepts, data, transactions, and entities that are related to the domain. The boundary of a domain may not completely overlap with the boundary of an organization. For example, a domain may be a subsidiary of a company. Various divisions or departments of the organization may have their own definitions, internal procedures, tasks, and entities. In other situations, multiple organizations may share the same domain. In many cases, the terms domain and organization may be used interchangeably.

The application 132 is a software application that operates at the client device 130. In some embodiments, an application 132 is published by the ontology management operator 105 to allow clients to communicate with the policy management server 110. For example, the application 132 may be part of a SaaS platform of the ontology management operator 105 that allows a client to create credit cards and accounts and perform various payment and spending management tasks. In various embodiments, an application 132 may be of different types. In some embodiments, an application 132 is a web application that runs on JavaScript and other backend algorithms. In the case of a web application, the application 132 cooperates with a web browser to render a front-end interface 134. In another embodiment, an application 132 is a mobile application. For example, the mobile application may run on Swift for iOS and other APPLE operating systems or on Java or another suitable language for ANDROID systems. In yet another embodiment, an application 132 may be a software program that operates on a desktop computer that runs on an operating system such as LINUX, MICROSOFT WINDOWS, MAC OS, or CHROME OS.

An interface 134 is a suitable interface for a client to interact with the policy management server 110. The client may communicate to the application 132 and the policy management server 110 through the interface 134. The interface 134 may take different forms. In some embodiments, the interface 134 may be a web browser such as CHROME, FIREFOX, SAFARI, INTERNET EXPLORER, EDGE, etc. and the application 132 may be a web application that is run by the web browser. In some embodiments, the interface 134 is part of the application 132. For example, the interface 134 may be the front-end component of a mobile application or a desktop application. In some embodiments, the interface 134 also is a graphical user interface (GUI) which includes graphical elements and user-friendly control elements. In some embodiments, the interface 134 does not include graphical elements but communicates with the data management server 120 via other suitable ways such as application program interfaces (APIs), which may include conventional APIs and other related mechanisms such as webhooks.

A transaction terminal 140 is an interface that allows an end user transaction device 120 to make electronic fund transfers with a third party. Electronic fund transfer can be credit card payments, automated teller machine (ATM) transfers, direct deposits, debits, online transfers, peer-to-peer transactions such as VENMO, instant-messaging fund transfers such as FACEBOOK PAY and WECHAT PAY, wire transfer, electronic bill payment, automated clearing house (ACH) transfer, cryptocurrency transfer, blockchain transfer, etc. Depending on the type of electronic fund transfers, a transaction terminal 140 may take different forms. For example, if an electronic fund transfer is a credit card payment, the transaction terminal 140 can be a physical device such as a point of sale (POS) terminal (e.g., a card terminal) or can be a website for online orders. An ATM, a bank website, a peer-to-peer mobile application, and an instant messaging application can also be examples of a transaction terminal 140. The third party is a transferor or transferee of the fund transfer. For example, in a card transaction, the third party may be a merchant. In an electronic fund transfer such as a card payment for a merchant, the transaction terminal 140 may generate a transaction data payload that carries information related to the end user transaction device 120, the merchant, and the transaction. The transaction data payload is transmitted to other parties, such as credit card companies, banks, and the authorizer server 160 for approval or denial of the transaction.

The transaction server 150 is a server that manages and forwards data of electronic fund transfer transactions to relevant parties for approval or denial of the underlying transactions. For example, the transaction server 150 belongs to a credit card company and receives a transaction data payload from a transaction terminal 140 for a pending transaction. The transaction server 150 forwards the transaction data payload to various parties such as banks and the authorizer server 160 to review the transaction. To ensure the end user experience of the card and a smooth approval process, the transaction server 150 may request the relevant parties to respond to the approval or denial within a timeframe such as by setting a timeout. Approval within the timeframe is considered a real-time approval process. The transaction server 150 and the transaction terminal 140 often belong to different parties. For example, the transaction server 150 may belong to a card company and the transaction terminal 140 may belong to a merchant.

The authorizer server 160 is a server that applies various policies set forth by a client of the ontology management operator 105 to approve or deny various transactions in real-time as the transaction server 150 forwards the transaction data payload to the authorizer server 160. The authorizer server 160 communicates with the policy management server 110 to retrieve policies for transaction approval and related data for the authorizer server 160 to make the approval decisions. In some embodiments, the authorizer server 160 and the policy management server 110 may be related but operate independently. For example, in some embodiments, the policy management server 110 and the authorizer server 160 are operated by the same parties but the two servers are associated with different architectures, code, and hardware. As such, the authorizer server 160 may be configured to operate as an independent server that specializes in approving fund transfer transactions (e.g., credit card payments) in real time. The operation of the authorizer server 160 is not affected by, for example, the downtime of the policy management server 110. In some embodiments, the policy management server 110 and the authorizer server 160 communicate with API. Examples of components and functionalities of the authorizer server 160 are discussed in further detail below with reference to FIG. 2. The authorizer server 160 may also be referred to as a second computing server or simply a computing server.

The authorizer data store 165 is a data store for the authorizer server 160. The authorizer data store 165 stores data that are relevant for the authorizer server 160 to make decisions on approving fund transfer transactions. In some embodiments, the authorizer data store 165 includes a partially replicated database of the data store 115 that is associated with the policy management server 110. The approval of a fund transfer transaction such as a card payment often is a quick decision process that requires the authorizer server 160 to respond within a time limit that is within a few seconds or within milliseconds. The authorizer data store 165 replicates the relevant data from data store 115 to reduce the latency in data retrieval and transfer of the data. In some embodiments, the authorizer data store 165 is local to the authorizer server 160. In other embodiments, the authorizer data store 165 is a Cloud database but has a simplified data structure and fewer data compared to the data store 115.

Various servers in this disclosure may take different forms. In some embodiments, a server is a computer that executes code instructions to perform various processes described in this disclosure. In another embodiment, a server is a pool of computing devices that may be located at the same geographical location (e.g., a server room) or be distributed geographically (e.g., cloud computing, distributed computing, or in a virtual server network). In some embodiments, a server includes one or more virtualization instances such as a container, a virtual machine, a virtual private server, a virtual kernel, or another suitable virtualization instance.

The network 170 provides connections to the components of the system environment 100 through one or more sub-networks, which may include any combination of local area and/or wide area networks, using both wired and/or wireless communication systems. In some embodiments, a network 170 uses standard communications technologies and/or protocols. For example, a network 170 may include communication links using technologies such as Ethernet, 802.11, worldwide interoperability for microwave access (WiMAX), 3G, 4G, Long Term Evolution (LTE), 5G, code division multiple access (CDMA), digital subscriber line (DSL), etc. Examples of network protocols used for communicating via the network 170 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over a network 170 may be represented using any suitable format, such as hypertext markup language (HTML), extensible markup language (XML), JavaScript object notation (JSON), structured query language (SQL). In some embodiments, some of the communication links of a network 170 may be encrypted using any suitable technique or techniques such as secure sockets layer (SSL), transport layer security (TLS), virtual private networks (VPNs), Internet Protocol security (IPsec), etc. The network 170 also includes links and packet-switching networks such as the Internet. In some embodiments, a data store belongs to part of the internal computing system of a server (e.g., the authorizer data store 165 may be part of the authorizer server 160). In such cases, the network 170 may be a local network that enables the server to communicate with the rest of the components.

### Example Server Components

FIG. 2 is a block diagram illustrating the components of a policy management server 110 and various components of an authorizer server 160, in accordance with some embodiments. The policy management server 110 includes a client profile management engine 205, an account management engine 210, a bulk invitation engine 215, a transaction policy management engine 220, a category identification engine 225, a named entity identification engine 230, an authorizer data selection engine 240, an interface 245, and a subroutine object store 250. The authorizer server 160 includes a data selection engine 260, a transaction approval engine 265, and an interface 270. In various embodiments, the two servers may include fewer or additional components. The two servers also may include different components. The functions of various components may be distributed in a different manner than described below. While in FIGS. 1 and 2 the ontology management operator 105 is illustrated as having two separate servers, in other embodiments the functionalities and features of the two servers are combined. The components in each server may also be allocated in a different manner shown in FIG. 2. Moreover, while each of the components in FIG. 2 may be described in a singular form, the components may present in plurality. The components may take the form of a combination of software and hardware, such as software (e.g., program code comprised of instructions) that is stored on memory and executable by a processing system (e.g., one or more processors).

The client profile management engine 205 stores and manages named entity data and transaction data of clients of the policy management server 110. The policy management server 110 serves various organizations that have different associated named entities such as employees, vendors, and customers. For example, the client profile management engine 205 may store the employee hierarchy of a client to determine the administrative privilege of an employee in creating a credit card account and in setting transaction policies. An administrator of the client may specify that certain employees from the financial department and managers have the administrative privilege to create cards for other employees. The client profile management engine 205 assigns metadata tags to the transaction data of an organization to categorize the transactions in various ways, such as by transaction types, by merchants, by date, by amount, by card, by employee groups, etc. The client profile management engine 205 monitors the spending of a client by category and also by the total spending. The spending amounts may affect the results of transaction policies that are specified by a client's system administrator. For example, a client may limit the total monthly spending of an employee group. The policy management server 110 may deny further card payments after the total spending exceeds the monthly budget.

The client profile management engine 205 may maintain, for each domain client, an organization chart that represents employee profiles as data objects and store the hierarchy of employees as a linked data object chain. For example, the linked chain may take the form of a branched tree that represents the hierarchy of employees and has nodes to represent employees. The information on the hierarchy of employees may be used as part of the transaction approval policy in clearing transactions and seeking approval on past rejected transactions. For example, an organization client may set forth a policy specifying that certain transactions require manager approval. The policy management server 110 may review the data object chain to identify, for a particular employee, who the manager is and send a notification to the manager.

The account management engine 210 creates and manages accounts including transaction accounts such as transaction cards that are issued by the policy management server 110. An account is associated with a named entity such as an employee and corresponds to a card. An account may further be linked to another named entity such as the employee's manager, who may have certain administrative privileges in controlling the account, such as approval of certain transactions that are not automatically approved. An organization client may use the policy management server 110 to issue domain-specific transaction accounts such as company cards. The client enters account information such as the cardholder's name, role and job title of the cardholder in the client's organization, limits of the card, and transaction policies associated with the card. In response, the account management engine 210 creates the card serial number, credentials, a unique card identifier, and other information needed for the generation of a transaction account and corresponding card. The card may take the form of a physical card or a virtual card. The account management engine 210 associates the information with the cardholder's identifier. For example, the policy management server 110 may create a data object that represents the account and links the data object to the data object that represents the cardholder's profile. The policy management server 110 communicates with a credit card company (e.g., VISA, MASTERCARD) to associate the card account created with the identifier of the policy management server 110 so that transactions related to the card will be forwarded to the authorizer server 160 for approval. The account management engine 210 may also order the production of the physical card that is issued under the payment management engine 110. The cards and transaction accounts created are associated with the transaction policies that are specified by the client's administrator.

The bulk invitation engine 215 allows the policy management server 110 to create a large number of transaction accounts and associated credit cards in a single selection. A client's administrator may select a large number of employees and request the policy management server 110 to create cards for the selected employees. The bulk invitation engine 215 apply one or more policies in both those accounts, such as setting certain permissions, restrictions, time limit, and spending limits. The administrator may also edit collectively or individually the card limits and policies associated with the group of cards. The group of cards may be associated with the same group identifier and can be activated, edited, or revoked at the same time. The bulk invitation engine 215 also allows the administrator to set up the manager relationships correctly for those cards, based on the hierarchy of employees. The accounts of a cardholder and her manager can be created at the same time with the proper limit and administrative privilege. For example, the manager is provided with the privilege to review and adjust the transaction policies of cards of her team members.

The transaction policy management engine 220 allows an administrator of an organization to specify policies for transactions for accounts of the organizations. A policy may be a rule and may be domain specific. For example, some policies can be generic to many domains, such as an initial limit for a transaction card. Other policies are specified by an individual domain. For example, a particular domain customer can set any special policies to be imposed on one or more transaction accounts. Transaction policies may include pre-transaction restrictions (e.g., spending rules), pre-authorization requirements, post-transaction approval or reporting requirements, and other suitable rules that may be applied to a transaction account. The policies may be based on transaction categories, merchant categories, specific merchants, time limits, date limits, amount limits, and/or other suitable criteria, whether the criteria are permanent or temporary, dynamic or predefined, party-specific or not. For example, an administrator, in creating or editing a transaction account (e.g., a card), may specify a date and time limit on the account. The date and time limit can be permanent (e.g., a card being invalid after a certain time and date), periodic (e.g., a card being invalid during weekends and holidays), temporary (e.g., a card being invalid between two dates), and dynamic (e.g., a card being valid or invalid based on other triggering conditions). The administrator may also specify a transaction amount limit for each transaction. The transaction amount limit is different from the card limit. The card limit specifies the total amount that a cardholder can spend for a period of time (e.g., monthly limit). The administrator may further specify a transaction amount limit for the maximum amount of spending for each transaction. In some cases, the limit of a card may also be aggregated toward the total limit of the organization.

The administrator may specify various limits using a portal provided by the policy management server 110. The administrator may also specify transaction category, merchant category, and specific merchants that are pre-approved or blacklisted for a specific card. The transaction policy management engine 220 stores various rules associated with each card as part of the variables associated with the card.

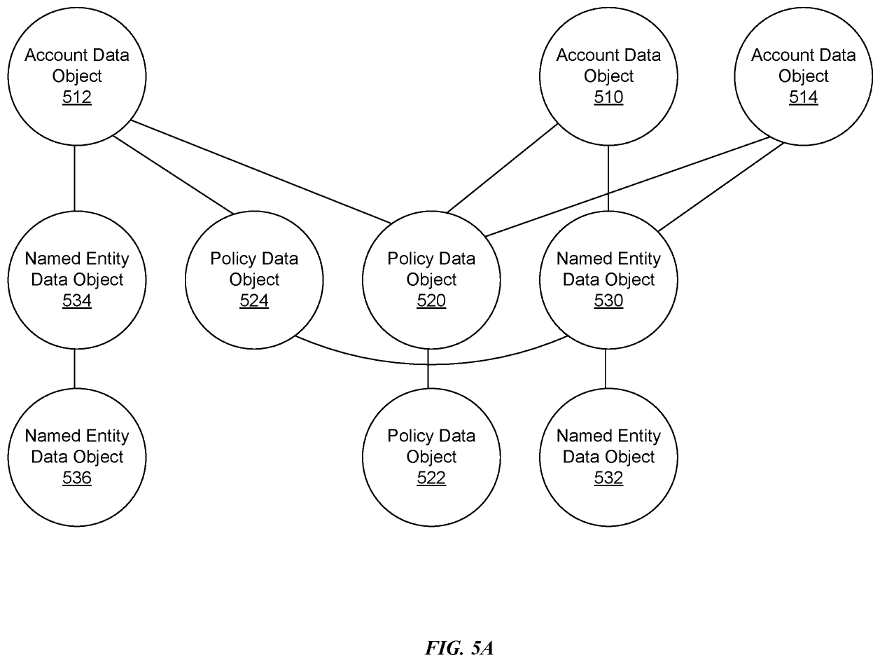

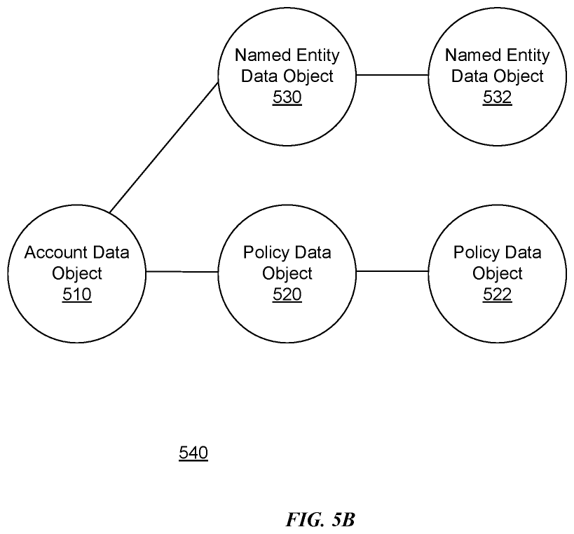

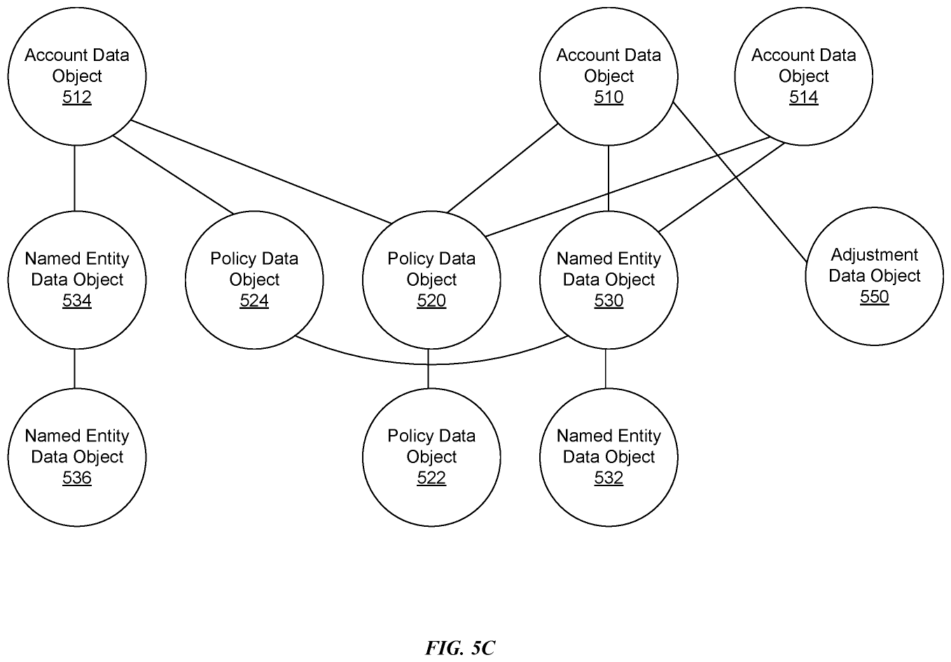

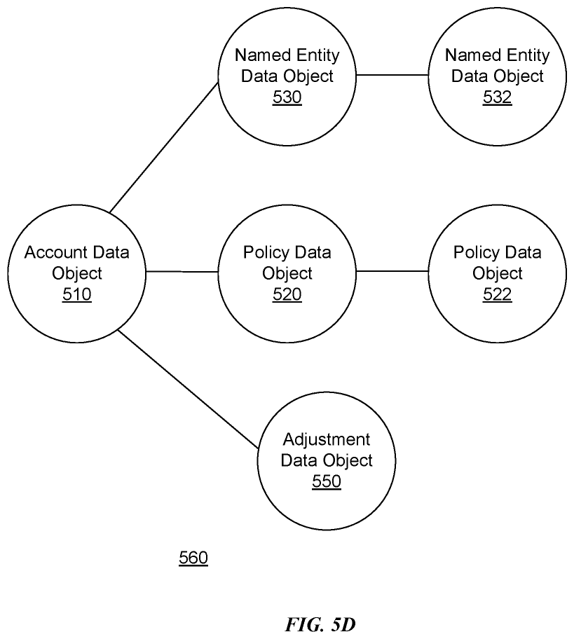

In some embodiments, the policy management server 110 may maintain each policy as a data object, which itself may be a chain of policy objects, such as different versions of the same policy, linking together. The policy data object may be connected (e.g., pointing, tagging) to various accounts that are represented by other types of data objects. The transaction policy management engine 220 may also maintain exceptions, pre-approval, and other special rules as data objects and assign those objects to an account. Various examples of the detailed structure of how policies are digitally represented are further discussed in FIG. 5A through FIG. 8B.

The category identification engine 225 identifies whether a transaction belongs to a particular merchant category provided by the policy management server 110. Example categories may include “Books and Newspapers,” “Car Rental,” “Clothing,” “Electronics,” “Entertainment,” etc. To set up a domain-specific category-based policy, an administrator may toggle each of the categories to authorize or restrict the use of a particular card. The policy management server 110 receives transaction data of credit payments and determines the category to which the transaction belongs. In some embodiments, the merchant categories provided by the policy management server 110 are different from the merchant category codes (MCC). In some embodiments, the policy management server 110 uses a lookup table to determine whether a transaction belongs to a category provided by the policy management server 110 based on MCC. For example, the MCC provides more than 200 categories while the customized categories of the policy management server 110 may include a small number of categories (e.g., less than 50 categories). A lookup table is constructed to map the MCC categories to the customized categories of the policy management server 110.

The named entity identification engine 230 identifies specific named entities (e.g., merchants) associated with various transactions. The computing server 110 may impose an entity-specific restriction on a card. For example, an administrator of a client may specify that a specific card can only be used with a specific named entity. The computing server 110 parses transaction data from different clients to identify patterns in the transaction data specific to certain named entities to determine whether a transaction belongs to a particular named entity. For example, in a card purchase, the transaction data includes merchant identifiers (MID), merchant category code (MCC), and merchant name. However, those items are often insufficient to identify the actual merchant of a transaction. The MID is often an identifier that does not uniquely correspond to a merchant. In some cases, the MID is used by the POS payment terminal company such that multiple real-world merchants share the same MID. In other cases, a merchant (e.g., a retail chain) is associated with many MIDs with each branch or even each registry inside a branch having its own MID. The merchant name also suffers the same defeats as the MID. The merchant name may also include different abbreviations of the actual merchant name and sometimes misspelling. The string of the merchant name may include random numbers and random strings that are not related to the actual real-world name of the merchant. The named entity identification engine 230 applies various algorithms and machine learning models to determine the actual merchant from the transaction data. For example, the named entity identification engine 230 may search for patterns in transaction data associated with a particular merchant to determine whether a transaction belongs to the merchant. For example, a merchant may routinely insert a code in the merchant name or a store number in the merchant name. The named entity identification engine 230 identifies those patterns to parse the actual merchant name.

A named entity identification process may be used to determine the identities of named entities included in processed real-time transactions. In one embodiment, the computing server 110 determines a named entity identification rule by analyzing patterns in the volume of data associated with the plurality of clients. For example, the volume of data may include past transaction data payloads of different clients. The computing server 110 may analyze the past transaction data payloads to determine a common pattern associated with the payloads of a particular named entity. The named entity identification rule may specify, for example, the location of a string, the prefix or suffix to be removed, and other characteristics of the data payload. The computing server 110, upon the receipt of a transaction data payload, identifies a noisy data field in the transaction data (e.g., a noisy string of text). A noisy data field is a field that includes information more than the named entity. For example, a noisy data field may include a representation of a named entity, such as the name, an abbreviation, a nickname, a subsidiary name, or an affiliation of the named entity. The noisy data field may further include one or more irrelevant strings that may be legible but irrelevant or may even appear to be gibberish. The computing server 110 parses the representation of the named entity based on the named entity identification rule. A transaction approval process can be based on the identity of the named entity. This general framework may be used by one or more computing servers to identify named entities in transaction data payloads.

U.S. Patent Application Publication No. 2022/0405477, entitled “Real-time Named Entity Based Transaction Approval” and filed on Dec. 22, 2022, is incorporated in its entirety herein for all purposes.

The authorizer data selection engine 240 selects data that is required by the authorizer server 160 to make approval decisions for transactions. The authorizer server 160 is required to provide approval or denial of many transactions related to various clients of the policy management server 110 in real-time with certain time limits. The policy management server 110 allows clients to specify various rules restricting the use of cards. The rules are normally not available for other cards because the rules are advanced controls that are not provided by credit card companies. The determination of the rules may require a server to retrieve relevant data from the policy management server 110 and apply the rules to the retrieved data. The authorizer data selection engine 240 reviews the rules associated with a particular client and determines, such as based on category identification engine 225 and named entity identification engine 230, data columns that should be sent to the authorizer server 160. In some embodiments, in response to an administrator of a client adjusting or creating a rule of the card, the authorizer data selection engine 240 triggers an update to the authorizer server 160.

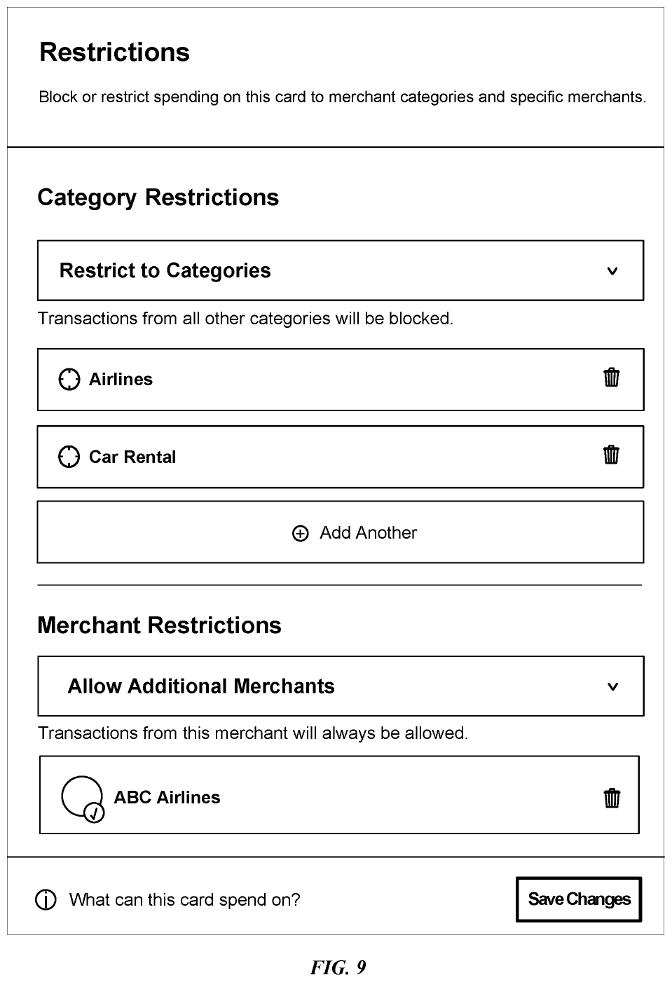

The interface 245 includes interfaces that are used to communicate with different parties and servers. The interface 245 may take the form of a SaaS platform that provides clients with access to various functionalities provided by the policy management server 110. The interface 245 provides a portal in the form of a graphical user interface (GUI) for clients to create transaction accounts, manage transactions, send bulk invitations and specify the rules of each card. Examples of the GUI elements of the interface 245 are shown in FIG. 9. The interface 245 is in communication with the application 132 and provides data to render the application 132. The interface 245 also communicates with the authorizer server 160 to provide data for the authorizer server 160 to perform transaction approval. The data may be provided by a push process such as an updated payload to the authorizer server 160 or a pull process upon the request of the authorizer server 160. The policy management server 110 may also send data payload to the authorizer server 160 periodically.

In some embodiments, the interface 245 also includes an API for clients of the policy management server 110 to communicate with the policy management server 110 through machines. The API allows the clients to retrieve the policy management server 110 stored in the data store 115, send query requests, and make settings through a programming language. Various settings, creation of cards, rules on the cards, and other functionalities of the various engines 205 through 240 may be changed by the clients by sending commands to the API. The API allows the clients to automate various processes such as spending control. For example, a client may retrieve spending data from the policy management server 110 and dynamically adjust, using code instructions specified by the client, the transaction policies of one or more cards. In another example, a client may integrate its own data and dynamically adjust the transaction policies of one or more cards. For instance, the client may log or provide the data log of an employee's working schedule. The data may be provided to the policy management server 110 to dynamically adjust the time that a card issued to the employee is authorized to use.

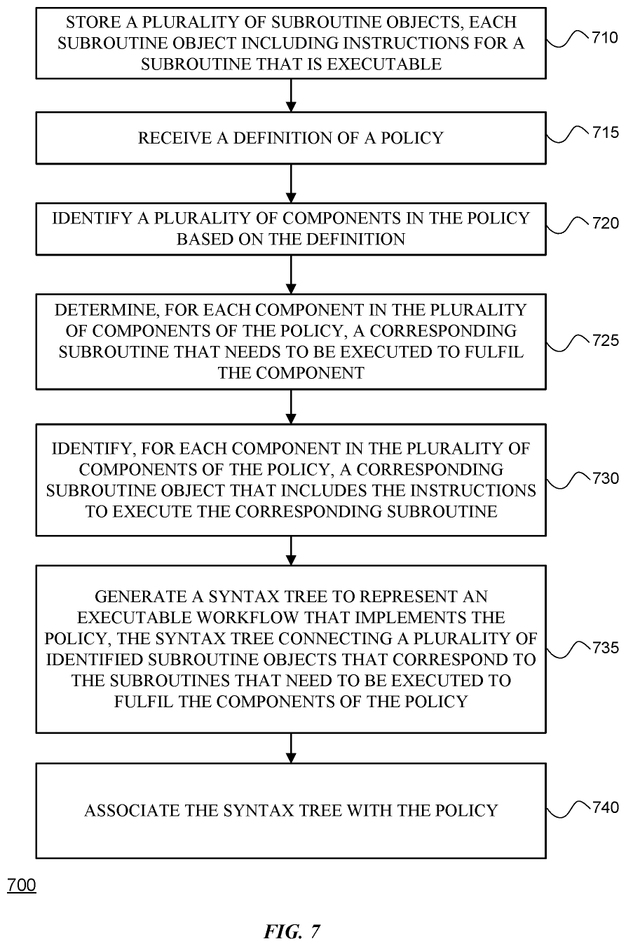

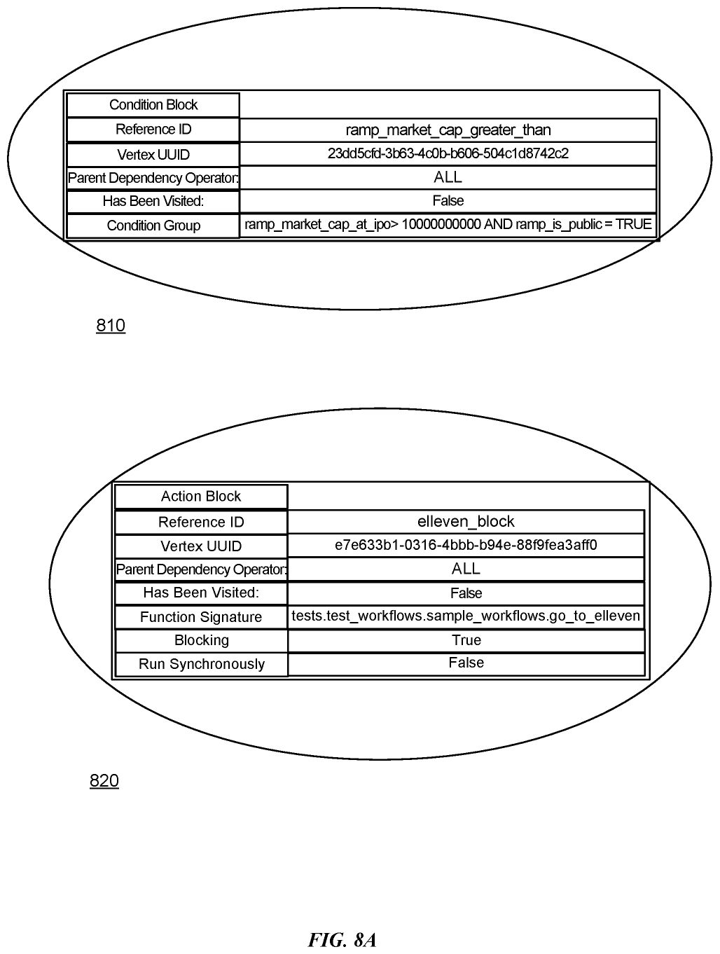

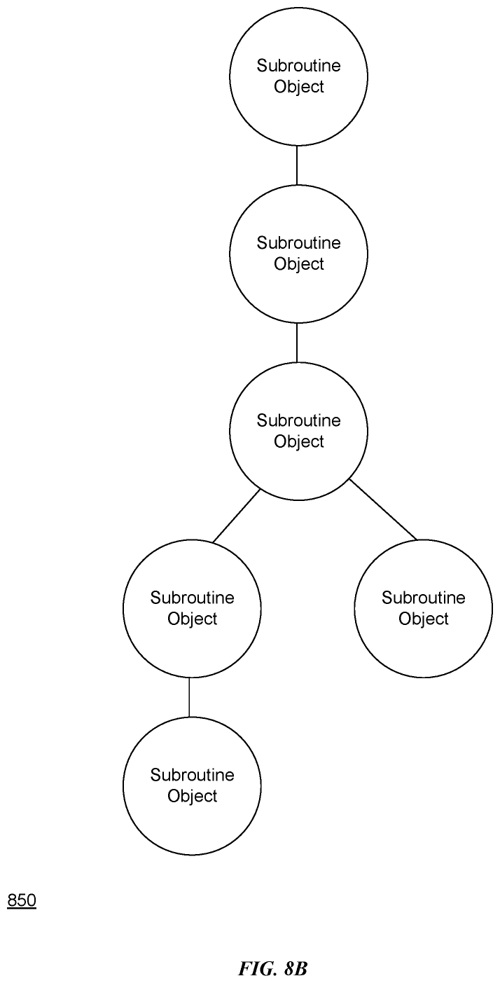

In some embodiments, the subroutine object store 250 is a data store that stores various subroutines as data objects. Each subroutine may be a unit of instructions that can be executed to carry out one or more actions or to verify one or more conditions. In some embodiments, the subroutine objects may be stored in a machine-code format so that the subroutine can be connected to form a syntax tree that is executable independent of the programming formats of a system that executes the syntax tree. A syntax tree may include a number of subroutine objects that are represented as vertices in the syntax tree and are linked to form a workflow. Executing a workflow allows a policy to be enforced. Each stored subroutine object is reusable in various workflows so that the subroutine objects can serve as building blocks for various workflows. A detailed discussion of the subroutine objects and workflow implementation of policy enforcement is further described in FIG. 7 through FIG. 8B.

Referring to the authorizer server 160, the authorizer server 160 may be an independent server that specializes in approving transactions based on card transaction policies that are specified by a client through the policy management server 110. The policy management server 110 may include a large amount of data and the data retrieval and calculation process of the policy management server 110 may not be fast enough to satisfy the time constraints in approval of a card transaction in real-time. The authorizer server 160 may include a partially replicated database that includes data relevant to transaction policies and approval of transactions to speed up the approval process. In some embodiments, the authorizer server 160 is in communication with the policy management server 110 but is not in direct communication with any of the clients of the policy management server 110. While the authorizer server 160 is illustrated as having only the data selection engine 260, the transaction approval engine 265, and the interface 270, the authorizer server 160 in some embodiments also include the functionality of the policy management server 110 such as any of the engines and interfaces 205 through 245. For example, when the authorizer server 160 receives a transaction data payload, the authorizer server 160 may need to identify the actual real-world merchant from the noisy data of the transaction data payload. The identification of the merchant functionality may be similar to or the same as the named entity identification engine 230.

The data selection engine 260 selects data needed to apply a transaction policy and approve a transaction. The data selection engine 260 makes a query to the authorizer data store 165 to retrieve the relevant data. The data selection engine 260 parses the card number in a transaction data payload to identify the transaction account and the client of the policy management server 110. The data selection engine 260 retrieves the policies that are associated with the cards. For example, the policies may be represented by data objects that are linked to other data objects. The data selection engine 260 may identify a chain of data objects that is relevant to completing the authorization request for the transaction. In turn, the data selection engine 260 may define a workflow to authorize the transaction by traversing the chain of data objects. The data selection engine 260 generates one or more database queries (e.g., a SQL query) based on the criteria specified in the chain of data objects.

In some embodiments, the data selection engine 260 also selects what data to be downloaded from the policy management server 110. For example, data in the data store 115 is stored as a form of structured data with column names. The data selection engine 260, based on the transaction policies, identifies columns that should be replicated from the data store 115 to the authorizer data store 165. Since the data in the authorizer data store 165 may be simplified and smaller in size than the data in the data store 115, the approval speed of the authorizer server 160 and the reliability and stability of the authorizer server 160 are improved.

The transaction approval engine 265 approves or denies a transaction based on various criteria including the transaction policies, such as spending limits, the overall limit of an organization set forth by the client, credential verification, fraud detection, etc. The transaction approval engine 265 identifies relevant data in the transaction payload and may make a determination with respect to the nature of the transaction. For example, the transaction approval engine 265, in response to a transaction policy that restricts a specific merchant or a merchant category, makes a prediction on the identity of the real-world merchant based on the noisy data in the transaction data payload. In turn, the transaction approval engine 265 makes an approval determination based on the identity of the merchant. A rule may also be a time limit. The transaction approval engine 265 parses the timing and date data from the transaction payload to determine whether the time and date violate any rule specified by the client. A rule may also be a per-transaction limit or a limit that counts toward the overall spending limit of an organization. The authorizer server 160 receives the data such as the overall spending of an organization from the policy management server 110 and makes an approval based on the data.

The interface 270 of the authorizer server 160 allows the authorizer server 160 to communicate with the appropriate parties and servers. The authorizer server 160 is in communication with the policy management server 110. When a new card of the policy management server 110 is created, the policy management server 110 specifies the Internet address of the interface 270 as the destination address for a credit company to forward the transaction data payload for approval or denial. Hence, although the creation and management of cards are performed through the policy management server 110, the approval process of the transactions associated with the cards is performed through the authorizer server 160.

While the authorizer server 160 and the policy management server 110 are illustrated as separate servers, in some embodiments, the authorizer server 160 may be part of the policy management server 110. For example, in some embodiments, the policy management server 110 may perform the card transaction approval instead of setting up a separate server. Also, in some embodiments, the authorizer server 160 may download one or more workflows from the policy management server 110, such as the workflows that are constructed from subroutine objects stored in the subroutine object store 250.

### Digitalized Policy Data Object Structure

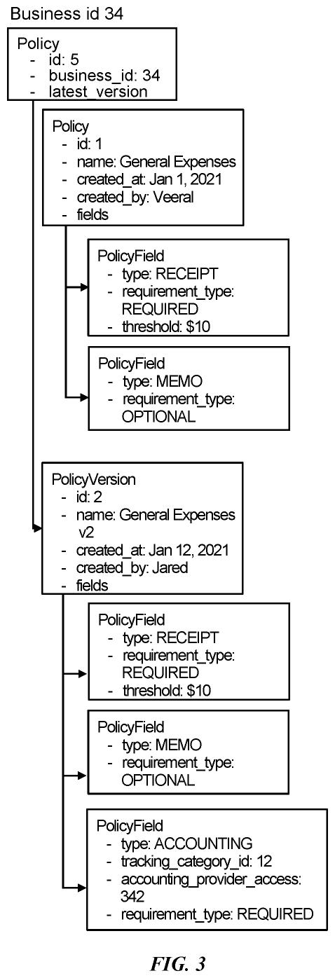

FIG. 3 is a conceptual diagram illustrating an example structure of data objects that represent a domain knowledge ontology of a domain maintained by the ontology management operator 105, in accordance with some embodiments. A domain may be a customer of the ontology management operator 105 and saves various information, specific policies, named entities, and transactions in the servers provided by the ontology management operator 105. The relationships among the policies, accounts, named entities, and transactions of a domain may represent part of the domain knowledge ontology of the domain. In some embodiments, the ontology management operator 105 may represent various concepts, named entities (e.g., individuals and companies), accounts, third-party platforms, domain departments, policies, records, and versions of a domain as data objects. The named entities may be named entities with the domain, such as employees, managers, and departments in an organization. The named entities may also be outside of the domain, such as merchants, vendors, and other third parties. Part of the domain knowledge ontology of the domain may be represented by the interconnections and the network of the data objects.

The data objects may take various suitable formats for storing in a database. For example, a data object may correspond to a data collection that includes data values describing attributing of the thing that is represented by the data object. The data values may take the form key-value pairs with certain common fixed keys that can be used in any data objects and unique keys for certain types of data objects. The keys may include data object identifier, name, type, threshold, and other suitable metadata fields. The types may be policy, individual, account, rule adjustment, domain department, etc. For the policy data objects, various policies may also be divided by types. The types can be receipt (e.g., requiring a receipt for a transaction), memo, accounting (tracking data field of a third-party platform), manager review, automatic locking, and other categories of rules that can be used to describe policies for whether to approve or deny transactions. The values in a data object can be attribute values or pointers (e.g., identifiers) of other data objects.

In some embodiments, the data objects may be versioned and store changes over time of the data objects. For example, a data object may store a list of versions with each version data object containing attributes and rules at a particular range of time. In some embodiments, the data objects being versioning instead of attribute values being overwritten allows the policy management server 110 to retrieve past data objects and apply rules and attribute values for transactions that occurred at a particular time. For example, in the context of policies, a policy data object may include a plurality of policy versions. The policy management server 110 may manage real-time transactions and past transactions for a domain customer. When the policy management server 110 receives data of a transaction, the policy management server 110 may determine the applicable timeframe for the transaction and review the correct version of the policy in determining actions to be performed associated with the transaction (e.g., approving, denying, or reporting the transaction).

Each data object may be nested with different layers that have various sub-data objects. For example, a policy data object may be nested with different versions of the policy. In some embodiments, the data objects may also be flattened to a list of attributes. The precise structure of the data object may vary, depending on embodiments.

The data objects may be connected to other data objects to signify the relationship among various concepts, named entities, and things. Two data objects may be connected by a pointer within a data object pointing to another data point. The pointer may take the form of a unique identifier of a data object. The relationship between two data objects may signify requirements, exceptions, and/or hierarchy between two data objects. For example, in the context of two named entity employees, the linking of the employee data objects may signify that the two employees are manager-team members or they are on the same team. A transaction account (e.g., a transaction card) may also be represented as a data object and may be connected to an employee data object to signify that the employee is the account holder, one or more policy data objects to signify that transactions carried by the account are under review of various policies, and adjustment data object to signify that the account may have a special exception or adjustment that is separately approved by an administrator such as the employee's manager.

Policy data objects can be of different types. For example, a policy may be a pre-transaction restriction such as a transaction limit, a transaction date, a time condition, a location limit, a category limit based on the category identification engine 225, a merchant limit based on the named entity identification engine 230, etc. A policy may also be an employee-level condition such as only allowing certain levels of employees to reach certain limits or perform certain transactions. A policy may also be a documentation requirement such as requiring a transaction to have a receipt and a memo explaining the nature of the transaction by the account owner. In some embodiments, the policy management server 110 also provides integration with third-party platforms such as third-party accounting platforms. A policy may include a documentation requirement that is linked to a particular field in a third-party platform. After the information is provided by the account owner who incurred the transaction, the information may be automatically updated and filled in the third-party platform based on the policy. The policy may also be a manager review. The transaction may require manager approval. The policy may further be a reverse reimbursement where the account holder (e.g., employee) is required to pay back the company for certain transactions if the transaction meets or fail to meet certain criteria.

A policy may also be an automatic lock account policy. The automatic lock account policy may be a post-transaction requirement specifying that one or more features of an account are suspended if the post-transaction requirement is not met. For example, the automatic lock account policy data object may be linked to other policy data objects such as documentation requirements. If the account fails to meet those other policies and the number of failures reaches a threshold after a certain period of time, the policy management server 110 may automatically lock the transaction account. For example, the policy management server 110 may periodically run each account data object in the server and determine if one or more accounts are in violation of one or more policies and whether those accounts are associated with an automatic lock account policy. If so, the policy management server 110 may lock the account permanently or until the violation has been remedied.

A policy may also be a temporary card limit. For example, the domain may set a time element in a transaction account. The limit of the transaction account may be increased or decreased over time. The time limit may be enforced by providing versioning to the policy. For example, when a temporary card limit is enforced, the policy may be associated with two versions. Each version has its own limit and one of the versions has an expiration time. This allows the change of card limit over time. For example, a transaction card may be set to have a temporary increase in spending limit for a period of a month based on a manager's approval. After the period, the transaction card may return to the default limit or be set to a new limit.

### Automatic Approval Workflow Identification

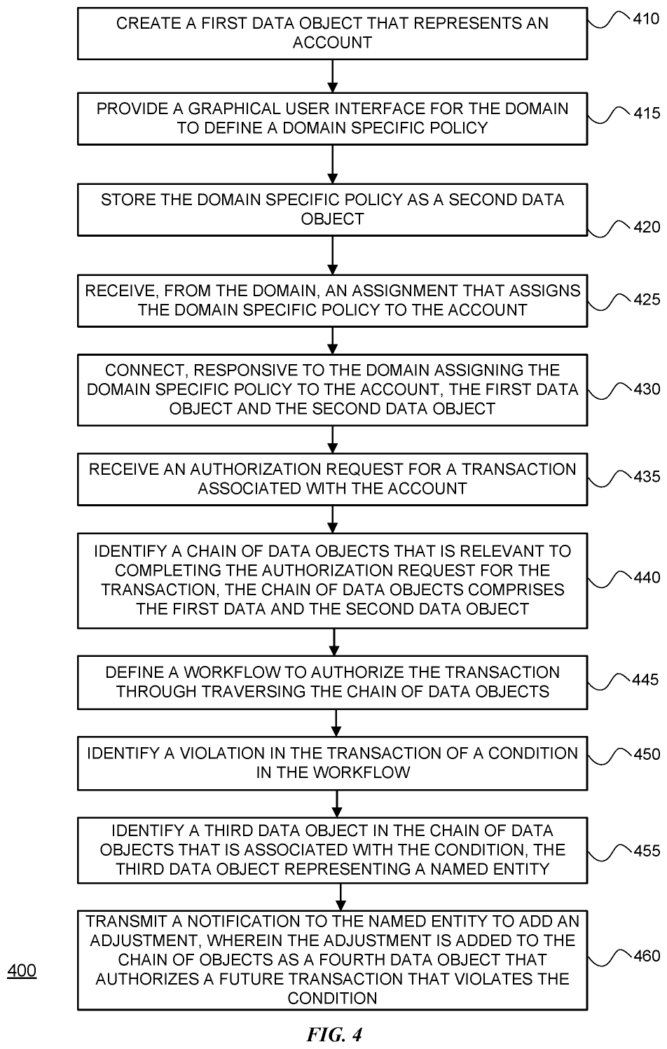

FIG. 4 is a flowchart depicting a computer-implemented process 400 for defining a transaction approval workflow based on a domain-specific policy, in accordance with some embodiments. For the particular embodiment discussed in FIG. 4, the policy management server 110 and the authorizer server 160 may be treated as the same server, although in some embodiments the steps in the process 400 may be distributed between the two servers. In process 400, the two servers may be generally and collectively referred to as a computing server, which may be controlled by the ontology management operator 105. The computing server includes one or more processors and memory. The memory stores a set of code instructions that, when executed by the one or more processors, causes the one or more processors to perform one or more steps described in the process 400.

FIG. 5A through FIG. 5D are conceptual diagrams illustrating a graphical representation of part of the domain knowledge ontology of a domain that includes various relationships among different concepts and things stored as data objects, in accordance with some embodiments. The relationships illustrated in FIG. 5A through FIG. 5D are representative relationships and actual data stored in the computing server may include numerous data objects that are interlinked. The illustrations in those figures are examples of graphical representations of some steps in process 400. FIG. 4 and FIG. 5A through FIG. 5D are illustrated together.

In some embodiments, the computing server may create 410, on behalf of a domain, a first data object that represents an account. In various embodiments, the domain may delegate transaction authorization of one or more transactions of the domain to the ontology management operator 105. For example, the domain is an organization customer of the ontology management operator 105 and uses the service of the ontology management operator 105 to generate various transaction accounts (e.g., transaction cards). The computing server may save each of the transaction accounts as data objects that may be referred to as account data objects. In FIG. 5A, exemplary accounts are shown as account data object 510, 512, and 514. Each account data object may include attributes such as a data object identifier, account number (e.g., card number), account holder, etc.

In some embodiments, the computing server may provide 415 a graphical user interface for the domain to define a domain-specific policy. For example, the computing server may provide a SaaS platform such as an administration portal for the domain administrator to define one or more policies that will govern the accounts. The policies may be specific to the domain as the policies are defined by the domains. The policies may be part of the domain's domain knowledge ontology that is maintained by the ontology management operator 105. A policy can be a default policy or a customized policy. An account can be associated with one or more policies.

In some embodiments, the computing server may store 420 a domain-specific policy as a data object. For example, three example policies are represented as policy data object 520, 522, and 524. In some embodiments, the computing server may receive 425, from the domain, an assignment that assigns a domain-specific policy to an account. In response to the domain assigning the domain-specific policy to the account, the computing server may connect 430 an account data object and a policy data object. For example, a domain may set up one or more policies from the portal provided by the ontology management operator 105. A policy may be specific to a particular account or may be applied to multiple accounts. For example, the domain may apply the policy in bulk to a large number of accounts. When a policy is assigned to an account, the computing server saves a connection between an account data object and a policy data objection. For example, in FIG. 5A, policy data object 520 is connected to account data object 510, 512, and 514. Policy data object 524 is connected to account data object 512 and the named entity data object 530. Two or more policies may also be chained. For example, the policy data object 520 and the policy data object 522 are connected.

In addition to linking to one or more policy data objects, an account data object may also be linked to other types of data objects. For example, the account data object 510 is connected to a named entity data object 530, which may represent the account holder of the account, such as a natural person employee. The named entity data object 530 may be further linked to another named entity data object 532. The connection may signify the relationship between the two named entities. For example, the employee represented by the named entity data object 532 may be the manager of the employee represented by the named entity data object 530.

In some embodiments, the computing server may receive 435 an authorization request for a transaction associated with an account. For example, the account may be a transaction card that attempts to incur a real-time transaction at a transaction terminal 140. In another example, the domain may receive an invoice and may use the account to conduct transactions to clear the invoice. The approval process of the transaction may have been delegated to the ontology management operator 105. One of the servers of the ontology management operator 105, such as the authorizer server 160, may receive transaction information from transaction server 150. Using the information, such as the card number in the transaction information, the computing server may identify an account and the corresponding account data object.

In some embodiments, the computing server may identify 440 a chain of data objects that is relevant to completing the authorization request for the transaction. The chain of data objects may be identified from the domain knowledge ontology of the domain. For example, based on the transaction information, the computing server may identify that the account represented by the account data object 510 is conducting a transaction. Through the account data object 510, the computing server may identify a chain of data objects 540 that includes the account data object 510, the policy data object 520, the policy data object 522, the named entity data object 530, and the named entity data object 532. The chain of data objects 540 is illustrated in FIG. 5B. The chain of data objects 540 is merely a representative example. In various embodiments, the chain may be much longer and may be linear, branched, looped, nested, or in any suitable topology as defined by the domain knowledge ontology.

In some embodiments, the computing server may define 445 a workflow to authorize the transaction through traversing the chain of data objects 540. For example, the computing server may traverse a branch of the data objects 540 may include two or more policy data objects 520, 522, etc. Each policy data object may include its own versions, rules, conditions, attributes, etc. to define the policy. By going through a policy data object, the computing server may determine the procedures (e.g., what needs to be checked) to be added to the workflow. For example, the computing server may add each of the requirements as defined in policy data objects 520, 522, etc. to the workflow as the computing server examines the ontology associated with the account data object 510 by traversing the chain of data objects 540. For example, the first policy may be a transaction limit. The second policy may be a category limit. The third policy may be a merchant limit. Each of the limits may be added to the workflow for the computing server to conduct the workflow to determine whether to approve a transaction. In some embodiments, the workflow is not predetermined but rather defined dynamically based on the domain knowledge ontology as a transaction is received.

The computing server checks the conditions in the workflow in order to determine whether to approve a transaction. If all conditions are met, the computing server approves the transaction on behalf of the domain. In some embodiments, the computing server may identify 450 a violation in the transaction of a condition in the workflow. The violation prevents the workflow from being completed. The condition may be a condition that is defined in a domain-specific policy that is stored as a policy data object linked to the account. For example, there may be a policy that limits the amount per transaction and the information in the current transaction indicates that the current transaction exceeds the limit. In such a case, the computing server may reject the transaction. In some embodiments, the computing server may notify the account holder of the precise reason why the transaction is rejected.

In some embodiments, the computing server may identify 455 as a data object in the chain of data objects that are associated with the condition that prevents the transaction from being approved. For example, the condition may be that the transaction amount being over a threshold will require approval from the manager of the account holder. Using the chain of data objects 540 to illustrate, the computing server may determine that the condition is stored in the policy data object 522. The computing server traces chain 540 to identify the account holder, which is represented by the named entity data object 530. In turn, based on the hierarchy of employees that are stored as a network of named entity data objects, the computing server may identify that the account holder's manager is represented by the named entity data object 532. As such, the computing server has identified the named entity data object 532 as the data object that is associated with the condition.

In some embodiments, the computing server may transmit 460 a notification to the named entity to add an adjustment. The computing server may generate a recommendation to the account on seeking approval of the transaction. For example, the computing server may first ask the account holder if the account holder would like to seek a manager's approval of the transaction. If so, the computing server, by identifying the named entity data object 532, sends a notification to the manager (an example of the named entity) to add an adjustment. The adjustment is added to the chain of objects as a data object that authorizes a future transaction that violates the condition. For example, referring to FIG. 5C, the adjustment data object 550 is created upon receiving the approval from the manager. The adjustment data object 550 is connected to the account data object 510. Referring to FIG. 5D, since the adjustment data object 550 is connected to the account data object 510, the chain of data objects 540 has become a new chain 560. When the computing server receives a transaction and determines dynamically the workflow for approving the transaction, the new workflow includes an exception that is defined by the adjustment data object 550. Even if a future transaction violates a condition that is set forth in one of the policy data objects, the adjustment may override the violation. This allows the computing device to approve future transaction.

In some embodiments, the recommendation to the account to seek approval of the transaction may be a second workflow that is presented to the account for the account holder to seek approval of the transaction. For example, the computing server, based on the domain knowledge as defined by the chain of data objects 540 determines that the transaction is declined for more than one violation. The computing server may automatically set up the second workflow to help the account holder to seek approval step by step. In some embodiment, even if only a single violation is identified, the violation may involve a nested condition or the adjustment of the policy may require a chain of managers or administrators to make the adjustment. The computing server may identify those conditions based on the domain knowledge and set up the second workflow.

In some embodiments, attaching an adjustment data object to an account data object for adjusting a policy does not affect other accounts that are also connected to the policy. For example, referring to FIG. 5C and FIG. 5D, the policy data object 520 is assigned to a plurality of accounts that are represented by the account data object 510, account data object 512, and account data object 514. The adjustment data object 550 is added to the chain of data objects 560 that is specific to the account data object 510. The computing server may store a connection between the account data object 510 and adjustment data object 550. The chain of data objects 560 has the adjustment data object 550 so that an exception is added to the policies. However, the adjustment data object 550 is not directly connected to the policy data object 520. As such, the policy represented by the policy data object 520 is not affected by the adjustment data object 550 for the two accounts represented by the account data object 512 and the account data object 514. This allows the computing server to identify bottlenecks or violations in a transaction approval workflow and add adjustments to the workflow without affecting the same policy for other accounts.

In some embodiments, a policy may be connected to different types of data objects so that the ontology management operator 105 may enforce cross-product rules for an organization. Referring to FIG. 5A, the policy data object 524 is connected to both an account data object 512 and a named entity data object 530. This may represent that the policy represented by the 524 is applied to an account represented by account data object 512 and also a named entity represented by the named entity data object 530. The named entity may be an employee or even a department of the domain. For example, the domain may define a spending limit for a named entity. The spending limit may be applied to the account represented by the account data object 512, which may represent a transaction card account. As a result, the transaction card account is subject to the spending limit.

In addition, the spending limit may be applied to the named entity represented by the named entity data object 530. The named entity may be associated with more than one account, such as the accounts represented by account data object 510 and account data object 514. Those accounts may be of different natures. For example, the account represented by the account data object 510 may be a transaction card that allows the account holder to conduct real-time transactions. The account represented by the account data object 514 may be a bank payment account that uses non-real-time transactions. When the computing server identifies a chain of data objects that include the policy data object 524 and named entity data object 530, the computing server determines that the named entity data object 530 is associated with different types of accounts. As such, the computing server applies the policy represented by the policy data object 524 to all accounts that are associated with the named entity data object 530. For example, the policy may be a spending limit. As such, the same limit may become a cross-product limit and be applied to a transaction card, a bank account, a reimbursement account, etc. As such, the domain may control the organization's spending of employees consistently across different products. In another example, the named entity data object 530 may represent a department in a domain. The named entity data object 530 is associated with a number of other named entity data objects, which represent the employees under the department. As such, the policy data object 524 may be enforced across the entire department. For example, a total spending limit may be applied to the total spending of the employees under the department. While spending limit is used as an example of the policy, other types of policy may equally be applied across multiple products and named entities.

### Example Machine Learning Models

In various embodiments, a wide variety of machine learning techniques may be used for identifying bottlenecks or violations in a workflow for approving a transaction, in accordance with some embodiments. Examples include different forms of supervised learning, unsupervised learning, and semi-supervised learning such as decision trees, support vector machines (SVMs), regression, Bayesian networks, and genetic algorithms. Deep learning techniques such as neural networks, including convolutional neural networks (CNN), recurrent neural networks (RNN) and long short-term memory networks (LSTM), may also be used. For example, various analyses of domain knowledge illustrated in FIG. 3 through FIG. 5D, generating recommendations for seeking transaction approval, and other processes may apply one or more machine learning and deep learning techniques.

In various embodiments, the training techniques for a machine learning model may be supervised, semi-supervised, or unsupervised. In supervised learning, the machine learning models may be trained with a set of training samples that are labeled. For example, for a machine learning model trained to identify approval workflow, the training samples may be one or more chains of data objects that represent another similar transaction workflow. The labels for each training sample may be binary or multi-class. In training a machine learning model for identifying approval workflow, the training labels may include a positive label that indicates the approval was successfully sought and a negative label that indicates the approval was not successfully sought. In some embodiments, the training labels may also be multi-class. For example, a training sample that represents a chain of data objects may have a label that identifies the named entity required to approve a transaction.

By way of example, the training set may include multiple past records with known outcomes. Each training sample in the training set may correspond to a past and the corresponding outcome may serve as the label for the sample. A training sample may be represented as a feature vector that includes multiple dimensions. Each dimension may include data of a feature, which may be a quantized value of an attribute that describes the past record. For example, in a machine learning model that is used to identify approval workflow, the features in a feature vector may include various attribute values of data objects, the relationship of data objects, the attributes in past transactions associated with the accounts involved in the transactions, etc. In various embodiments, certain pre-processing techniques may be used to normalize the values in different dimensions of the feature vector.

In some embodiments, an unsupervised learning technique may be used. The training samples used for an unsupervised model may also be represented by features vectors, but may not be labeled. Various unsupervised learning techniques such as clustering may be used in determining similarities among the feature vectors, thereby categorizing the training samples into different clusters. In some cases, the training may be semi-supervised with the training set having a mix of labeled samples and unlabeled samples.

A machine learning model may be associated with an objective function, which generates a metric value that describes the objective goal of the training process. The training process may intend to reduce the error rate of the model in generating predictions. In such a case, the objective function may monitor the error rate of the machine learning model. In a model that generates predictions, the objective function of the machine learning algorithm may be the training error rate when the predictions are compared to the actual labels. Such an objective function may be called a loss function. Other forms of objective functions may also be used, particularly for unsupervised learning models whose error rates are not easily determined due to the lack of labels. In some embodiments, in identifying approval workflow, the objective function may correspond to predicting the conditions of getting a transaction approved. In various embodiments, the error rate may be measured as cross-entropy loss, L1 loss (e.g., the sum of absolute differences between the predicted values and the actual value), L2 loss (e.g., the sum of squared distances).

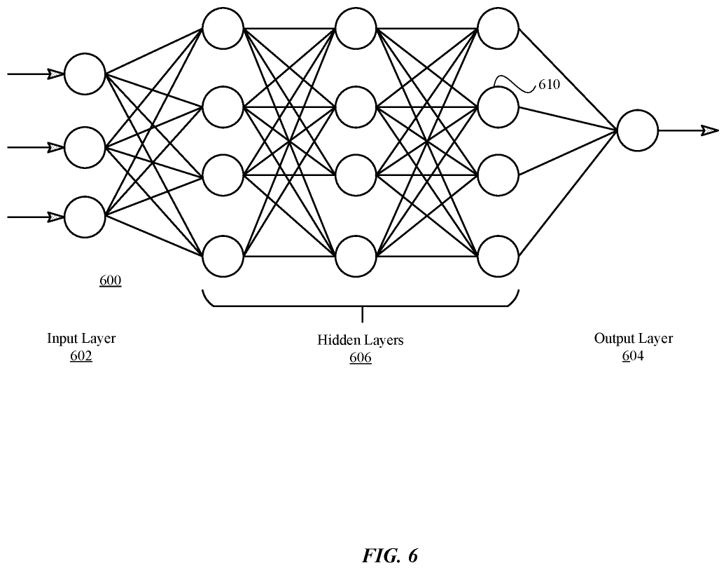

Referring to FIG. 6, a structure of an example neural network is illustrated, in accordance with some embodiments. The neural network 600 may receive an input and generate an output. The input may be the feature vector of a training sample in the training process and the feature vector of an actual case when the neural network is making an inference. The output may be the prediction, classification, or another determination performed by the neural network. The neural network 600 may include different kinds of layers, such as convolutional layers, pooling layers, recurrent layers, fully connected layers, and custom layers. A convolutional layer convolves the input of the layer (e.g., an image) with one or more kernels to generate different types of images that are filtered by the kernels to generate feature maps. Each convolution result may be associated with an activation function. A convolutional layer may be followed by a pooling layer that selects the maximum value (max pooling) or average value (average pooling) from the portion of the input covered by the kernel size. The pooling layer reduces the spatial size of the extracted features. In some embodiments, a pair of convolutional layer and pooling layer may be followed by a recurrent layer that includes one or more feedback loops. The feedback may be used to account for spatial relationships of the features in an image or temporal relationships of the objects in the image. The layers may be followed by multiple fully connected layers that have nodes connected to each other. The fully connected layers may be used for classification and object detection. In one embodiment, one or more custom layers may also be presented for the generation of a specific format of output. For example, a custom layer may be used for image segmentation for labeling pixels of an image input with different segment labels.

The order of layers and the number of layers of the neural network 600 may vary in different embodiments. In various embodiments, a neural network 600 includes one or more layers 602, 604, and 606, but may or may not include any pooling layer or recurrent layer. If a pooling layer is present, not all convolutional layers are always followed by a pooling layer. A recurrent layer may also be positioned differently at other locations of the CNN. For each convolutional layer, the sizes of kernels (e.g., 3×3, 5×5, 7×7, etc.) and the numbers of kernels allowed to be learned may be different from other convolutional layers.

A machine learning model may include certain layers, nodes 610, kernels and/or coefficients. Training of a neural network, such as the NN 600, may include forward propagation and backpropagation. Each layer in a neural network may include one or more nodes, which may be fully or partially connected to other nodes in adjacent layers. In forward propagation, the neural network performs the computation in the forward direction based on the outputs of a preceding layer. The operation of a node may be defined by one or more functions. The functions that define the operation of a node may include various computation operations such as convolution of data with one or more kernels, pooling, recurrent loop in RNN, various gates in LSTM, etc. The functions may also include an activation function that adjusts the weight of the output of the node. Nodes in different layers may be associated with different functions.

Training of a machine learning model may include an iterative process that includes iterations of making determinations, monitoring performance of the machine learning model using the objective function, and backpropagation to adjust the weights (e.g., weights, kernel values, coefficients) in various nodes 610. For example, a computing device may receive a training set that includes a chain of data objects and a past transaction. Each training sample in the training set may be assigned labels indicating how the past transaction was approved. The computing device, in a forward propagation, may use the machine learning model to generate a predicted way to get the transaction approved. The computing device may compare the predicted outcome with the labels of the training sample. The computing device may adjust, in a backpropagation, the weights of the machine learning model based on the comparison. The computing device backpropagates of one or more error terms obtained from one or more loss functions to update a set of parameters of the machine learning model. The backpropagating is performed through the machine learning model and one or more of the error terms based on a difference between a label in the training sample and the generated predicted value by the machine learning model.

By way of example, each of the functions in the neural network may be associated with different coefficients (e.g., weights and kernel coefficients) that are adjustable during training. In addition, some of the nodes in a neural network may also be associated with an activation function that decides the weight of the output of the node in forward propagation. Common activation functions may include step functions, linear functions, sigmoid functions, hyperbolic tangent functions (tan h), and rectified linear unit functions (ReLU). After an input is provided into the neural network and passes through a neural network in the forward direction, the results may be compared to the training labels or other values in the training set to determine the neural network's performance. The process of prediction may be repeated for other samples in the training sets to compute the value of the objective function in a particular training round. In turn, the neural network performs backpropagation by using gradient descent such as stochastic gradient descent (SGD) to adjust the coefficients in various functions to improve the value of the objective function.

Multiple rounds of forward propagation and backpropagation may be performed. Training may be completed when the objective function has become sufficiently stable (e.g., the machine learning model has converged) or after a predetermined number of rounds for a particular set of training samples. The trained machine learning model can be used for analyzing chains of data objects for transaction approval or another suitable task for which the model is trained.

### Workflow Policy Implementation

FIG. 7 is a flowchart depicting a computer-implemented process 700 for defining a syntax tree that defines a workflow for implementing a policy, in accordance with some embodiments. For the particular embodiment discussed in FIG. 7, the policy management server 110 and the authorizer server 160 may be treated as the same server, although in some embodiments the steps in the process 700 may be distributed between the two servers. In process 700, the two servers may be generally and collectively referred to as a computing server. The computing server may manage one or more subroutine objects that are stored in the subroutine object store 250. FIG. 8A is a conceptual diagram illustrating two example types of subroutine objects, in accordance with some embodiments. FIG. 8B is a conceptual diagram illustrating an example syntax tree that defines a workflow for implementing a policy, in accordance with some embodiments. FIGS. 7, 8A and 8B are discussed in conjunction with each other.

In some embodiments, a computing server may store 710 a plurality of subroutine objects. Each subroutine object includes instructions for a subroutine that is executable. A subroutine object may be a set of instructions packaged together to carry out a subroutine. The subroutine objects may be stored in a data store, such as subroutine object store 250, and is available for inclusion and use in different workflows. In some embodiments, the subroutine objects may be machine-code objects that are stored as binary instructions. The binary instructions are executable in any system environment agnostic of domain restrictions, operating systems, programming languages used, and other system-specific requirements.

FIG. 8A is a conceptual diagram illustrating two example types of subroutine objects, in accordance with some embodiments. The two examples are a condition subroutine object 810 and an action subroutine object 820. While two explicit examples are provided, in some embodiments there can be additional types of subroutine objects that define other goals. Subroutine objects can be building blocks of a larger workflow, which may include different subroutine objects that are linked together.

Each subroutine object may include parameters and a set of instructions that define a subroutine. The parameters may define and identify the subroutine object. In some embodiments, the condition subroutine object 810 defines a particular subroutine that includes one or more conditions to be checked to complete the particular routine. In the condition subroutine object 810, the parameters may include a reference identifier, a vertex universal unique identifier (UUID) that uniquely identifies the subroutine object, a parent dependency operator, a binary parameter for determining whether the object has been visited in a syntax tree, and a condition group parameter that defines the conditions.

The condition group parameter may include one or more conditions that are used to define the condition subroutine object 810. Conditions can be a quantity, a binary variable, a named entity representation, a reference to another subroutine object, and other suitable conditions that are discussed in this disclosure, such as one or more conditions that are received and managed by the transaction policy management engine 220. The instructions of the condition subroutine object 810, when executed, cause a computing device to carry out the determination of conditions based on the parameters specified in the condition subroutine object 810. For example, a condition may be as simple as comparing an input argument to a predefined quantity (e.g., the transaction amount is larger than a certain predefined amount) or determining a binary outcome (e.g., whether approval is received) or may be more complex such as determining a dynamic condition based on a function, or executing a machine learning model.

Conditions may be of different natures, such as a start condition that defines how a policy workflow may be applicable to a particular situation, an ending condition that defines how a workflow may end, an approval condition that defines one or more conditions that may satisfy a policy, a time-out condition that may define how a workflow may temporarily be stopped and how the workflow may be resumed, a logic condition that may define certain logics in a determination, a trigger condition that may define how an action or another condition is triggered, and a branch condition that may how a workflow may be divided into two or more branches. In some embodiments, any other suitable conditions may be added in a condition subroutine object 810.

Another example of a subroutine object is the action subroutine object 820, which defines a particular subroutine that includes one or more actions to be performed to complete the particular subroutine. In some embodiments, the parameters of the action subroutine object 820 may include a reference identifier, a vertex universal unique identifier that uniquely identifies the subroutine object, a parent dependency operator, a binary parameter for determining whether the object has been visited in a syntax tree, a function signature that defines one or more action subroutines, a blocking parameter and a synchronous determination parameter that defines whether an action may be carried out synchronously with another action.

An action may be an act that may be executed by a party operating a computing device that executes the action subroutine object 820. For example, the action may be carried out by the policy management server 110 to carry out part of a workflow in implementing a policy. In some embodiments, the action may also be carried out by the authorizer server 160, for example, in a real-time transaction approval process. In some embodiments, the action subroutine object 820 may be transmitted to a device belonging to an organization that enforces a policy for the organization to carry out.

Actions may vary depending on embodiments and how individual action is defined. For example, an action may be a series of steps that causes an email server to generate an email to a recipient. Another example may be an in-application action to seek approval from a user. Yet another example may be carrying out a transaction of a certain amount. Yet another example may be updating a database record. Yet another example may be sending a notification to a user or a group of users. Yet another example may be sending a document request (e.g., uploading a receipt) to a user. Yet another example may be performing a calculation that is based on the instructions in the subroutine. Actions may be of any nature and are not limited to particular examples provided in this disclosure.

The routine objects in FIG. 8A are illustrated in human-readable forms but, in some embodiments, each routine object may be compiled to executable instructions in a particular code format such as bytecode or binary machine code. In some embodiments, the routine objects are stored as a set of binary machine instructions. For example, the computing server, based on inputs from a system administrator, may generate parameters and executable routines of a subroutine function in a source code format. The computing server may compile the subroutine function into binary instructions as one of the subroutine objects. The computing server may store the subroutine object in a data store, such as the subroutine object store 250.

Various subroutine objects may be available as components of one or more policies. For example, the computing server may store various conditions and actions as subroutine objects that are re-useable for various workflows. For example, one subroutine object may include the executable instructions for sending an email. Another subroutine object may include the executable instructions for sending a text message. The subroutine objects may serve as building blocks of one or more workflows. As discussed in further detail below, a series of subroutine objects may be connected to generate a workflow that is customized to implement a particular policy.

Returning to FIG. 7, in some embodiments, a computing server may receive 715 a definition of a policy. For example, the computing server may provide a front-end interface such as a SaaS platform that allows a customer (e.g., an administrator of a domain) to define a policy. The interface may be designed with options that correspond to subroutine objects stored by the computing server. In some embodiments, the computing server may provide a list of candidate actions and/or conditions for a domain. Each action or condition may correspond to a subroutine object that is stored. The computing server may receive, from the domain, a selection of actions and/or conditions to define the policy. For example, a selected action or condition may correspond to a component of the policy. The process 700 may be used to implement any policies that are described in the format shown in FIG. 3 through FIG. 5D.

FIG. 9 is a conceptual diagram of a GUI that allows a customer of the computing server to define a card restriction policy for transactions that involve the customer's employee accounts issued by the policy management server 110. The platform may provide restrictions to categories, restrictions to merchants, and other restrictions that are not shown in the figure such as transaction amount limit. Each of the restrictions may be represented by a subroutine object. The customer may define the restriction policy by selecting one or more options that are presented in the GUI. For example, a policy may be a spending account may be restricted to airlines and car rental with the merchant ABC Airlines and each transaction is limited to below $1000. Another customer may define another domain-specific policy that has different restrictions. These selections represent non-limiting examples of definitions of policies that may be specified by customers.

While various examples discussed in this disclosure are related to spending or financial transactions, the policies that may be implemented using the routine objects can be of any nature and are not limited to the explicit examples stated in this disclosure. For example, policies may be related to notifications, authentication, authorizations, security, work automation, etc.

Returning to FIG. 7, in some embodiments, a computing server may identify 720 as a plurality of components in the policy based on the definition. Each component may be an action, a condition, or another suitable component. For example, a policy definition may define an approval process for a transaction that includes a start condition that defines the type of transaction that is applicable to the policy, an approval process for the transaction, and the conditions that will satisfy the policy. Each of those components may be isolated and identified by the computing server.

In some embodiments, a computing server may determine 725, for each component in the plurality of components of the policy, a corresponding subroutine that needs to be executed to fulfill the component. The type of subroutine that needs to be executed to fulfill the component may depend on the nature of the component and, in some cases, domain-specific knowledge. In some cases, a component may have a clear corresponding subroutine. For example, a component that defines a rule to compare a condition may correspond to the routine that carries out the rule. In other cases, more than one subroutine may fit the description of the component and the computing server may select one or more subroutines that are fit to fulfill the component. For example, the component may be an action such as notifying a user of a transaction and seeking approval from the user. There can be a few subroutines that may fit this component's goals, such as a subroutine that notifies the user by a text message and another subroutine that notifies the user by email. Whether the subroutine of sending a text message or the subroutine of sending an email may be selected may be defined in the policy itself or may be selected based on the environment of the domain. For example, there may be a domain-specific rule that an approval routine is required to be transmitted through a particular channel. The selection of a subroutine may also depend on the nature of the transaction, such as whether time sensitivity, the transaction amount, and other issues.

In some embodiments, a computing server may identify 730, for each component of the policy, a corresponding subroutine object that includes the instructions to execute the corresponding subroutine. The computing server may retrieve one or more subroutine objects that are stored in the subroutine object store 250. For example, if one of the subroutines that implement sending a text message to a user is selected, the corresponding subroutine object that includes instructions for sending a text message is retrieved from the subroutine object store 250. A policy may include one or more actions and/or conditions that define the policy. The computing server may select a set of subroutine objects that correspond to those actions and conditions.

In some embodiments, a computing server may generate 735 a syntax tree to represent an executable workflow that implements the policy. A syntax tree connects the identified subroutine objects that correspond to the subroutines that need to be executed to fulfill the components of the policy. The syntax tree may include the identified subroutine objects that are represented as vertices and the vertices are connected to form the executable workflow in one or more orders. The syntax tree may include any number of vertices that are linked together in any suitable ways, branched or linear, cyclic or acyclic. In some embodiments, the syntax tree may be in a binary machine code format and may be referred to as a binary-code syntax tree.

FIG. 8B is a conceptual diagram that illustrates an example syntax tree 850, in accordance with some embodiments. The syntax tree 850 may be a directed set of subroutines that are connected. Each subroutine object in the syntax tree 850 may include a subroutine and may be identified by a vertex UUID. The syntax tree 850 may be defined by a set of vertex UUIDs, each referring to one or more parent vertices and one or more child vertices. Each vertex represents a subroutine object that includes executable instructions for a subroutine. Together, the subroutines define a workflow that is custom to implementing a specific policy. The subroutine objects may serve as the blockchain blocks of a policy workflow and may be reused in other workflows. In some embodiments, the syntax tree 850 may be stored in the format of machine code such as binary instructions. This allows various syntax trees that are maintained by the computing server to be executed without the dependency on specific programming environments of various domain customers of the computing server.

Returning to FIG. 7, in some embodiments, a computing server may associate 740 the syntax tree with the policy of the domain. For example, the computing server may store the syntax tree in a data store and store an association between the syntax tree and the policy identifier of the policy to indicate that the policy is to be enforced by executing the syntax tree. The policy identifier may be associated with a domain identifier that identifies the domain. In some embodiments, when a transaction is initiated, the computing server may scan through various syntax trees that are associated with a domain. The computing server may examine the first vertex in a syntax tree to determine whether a policy should be applied to the transaction. In response to determining that the policy is applicable, the computing server initiates the policy workflow by executing the corresponding syntax tree.

In some embodiments, the computing server, such as the policy management server 110 or the authorizer server 160, may provide a SaaS platform to various domain customers that define different policies in different settings. The computing may store different syntax trees for various domain customers. For example, the computing server may store a first syntax tree that is associated with a first policy of a first domain and store a second syntax tree with a second policy of a second domain that is different from the first domain. In some embodiments, the computing server may store the subroutine objects in a format that is agnostic to the programming environments of various domains. For example, the subroutine objects may be stored in a machine code format. As such, the subroutine objects may be shared among various domains. For instance, the first syntax tree and the second syntax tree that are associated with different domain customers may share one or more subroutine objects that are stored by the computing server. For example, the subroutine object of sending a text message to a user may be re-used multiple times in various workflows without the computing server having to implement a program-specific send message code section in carrying out policy enforcement of various domains.

While in this disclosure the workflow is discussed with example embodiments where a computing server is delegated by a domain to carry out a particular type of policy enforcement, in some embodiments the workflows built by subroutine objects may also be directly carried out by the domain itself.

In some embodiments, by constructing workflows using subroutine objects as building blocks, the computing server may easily modify a policy based on a modification from a customer. For example, the computing server may receive a modification of the policy. The computing server may modify the corresponding syntax tree, such as by inserting a subroutine object into the syntax tree or removing a subroutine object from the syntax tree. For example, a first version of the transaction approval policy may include a condition component to check whether the transaction amount exceeds a threshold and an action component that rejects those transactions with the transaction amount exceeding the threshold. A second version of the transaction approval policy may be modified such that the transactions with the transaction amount exceeding the threshold will need manual approval. One or more subroutine objects that represent an approval process (such as a subroutine of sending a notification and a subroutine of receiving an approval) may be inserted as additional vertices of the syntax tree. As such, no specific programming code may need to be manually added to a policy enforcement workflow when the policy is changed. After the syntax tree is modified, the computing server stores the syntax tree as a modified workflow that implemented the policy as modified.

The stored syntax trees are used to implement various policy enforcements. For example, the computing server may receive a transaction request. The computing server may determine that the transaction request is subject to a policy. For example, the computing server may scan through the first subroutine objects in various syntax trees that are associated with the domain and determine which syntax trees are applicable to the transaction. The computing server may execute the syntax tree to determine whether the transaction request is compliant with the policy. For example, a policy may require manual authorization from a named entity. The computing server may execute the first set of instructions to communicate to a named entity for an authorization request. The computing server may execute a second set of instructions to compare a response of the authorization request to a condition defined in one of the subroutine objects in the syntax tree.

### ADDITIONAL CONSIDERATIONS

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Any feature mentioned in one claim category, e.g., method, can be claimed in another claim category, e.g., computer program product, system, storage medium, as well. The dependencies or references back in the attached claims are chosen for formal reasons only. However, any subject matter resulting from a deliberate reference back to any previous claims (in particular multiple dependencies) can be claimed as well, so that any combination of claims and the features thereof is disclosed and can be claimed regardless of the dependencies chosen in the attached claims. The subject matter may include not only the combinations of features as set out in the disclosed embodiments but also any other combination of features from different embodiments. Various features mentioned in the different embodiments can be combined with explicit mentioning of such combination or arrangement in an example embodiment or without any explicit mentioning. Furthermore, any of the embodiments and features described or depicted herein may be claimed in a separate claim and/or in any combination with any embodiment or feature described or depicted herein or with any of the features.

In some embodiments, a computer-readable medium includes one or more computer-readable media that, individually, distributedly, or together, include instructions that, when executed by one or more processors, cause the one or more processors to perform, individually, distributedly, or together, the steps of the instructions stored on the one or more computer-readable media. Similarly, a processor includes one or more processors or processing units that, individually, distributedly, or together, perform the steps of instructions stored on a computer-readable medium.

Some portions of this description describe the embodiments in terms of algorithms and symbolic representations of operations on information. These operations and algorithmic descriptions, while described functionally, computationally, or logically, are understood to be implemented by computer programs or equivalent electrical circuits, microcode, or the like. Furthermore, it has also proven convenient at times, to refer to these arrangements of operations as engines, without loss of generality. The described operations and their associated engines may be embodied in software, firmware, hardware, or any combinations thereof.

Any of the steps, operations, or processes described herein may be performed or implemented with one or more hardware or software engines, alone or in combination with other devices. In some embodiments, a software engine is implemented with a computer program product comprising a computer-readable medium containing computer program code, which can be executed by a computer processor for performing any or all of the steps, operations, or processes described. The term “steps” does not mandate or imply a particular order. For example, while this disclosure may describe a process that includes multiple steps sequentially with arrows present in a flowchart, the steps in the process do not need to be performed in the specific order claimed or described in the disclosure. Some steps may be performed before others even though the other steps are claimed or described first in this disclosure. Likewise, any use of (i), (ii), (iii), etc., or (a), (b), (c), etc. in the specification or in the claims, unless specified, is used to better enumerate items or steps and also does not mandate a particular order.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. In addition, the term “each” used in the specification and claims does not imply that every or all elements in a group need to fit the description associated with the term “each.” For example, “each member is associated with element A” does not imply that all members are associated with an element A. Instead, the term “each” only implies that a member (of some of the members), in a singular form, is associated with an element A. In claims, the use of a singular form of a noun may imply at least one element even though a plural form is not used.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights.

What is claimed is:

1. A computer-implemented method, comprising:
storing a plurality of machine-code subroutine objects, each machine-code subroutine object including instructions for a subroutine that is executable;
receiving a definition of a policy;
identifying a plurality of components in the policy based on the definition;
determining, for each component in the plurality of components of the policy, a corresponding subroutine that needs to be executed to fulfill the component;
identifying, for each component in the plurality of components of the policy, a corresponding machine-code subroutine object that includes the instructions to execute the corresponding subroutine;
generating a machine-code syntax tree to represent an executable workflow that implements the policy, the machine-code syntax tree connecting a plurality of identified machine-code subroutine objects that correspond to the subroutines that need to be executed to fulfill the components of the policy; and
associating the machine-code syntax tree with the policy.

2. The computer-implemented method of claim 1, wherein the machine-code syntax tree comprises the plurality of identified machine-code subroutine objects that are represented as vertices and the vertices are connected to form the executable workflow in one or more orders.

3. The computer-implemented method of claim 1, further comprising:
receiving a transaction request;
determining that the transaction request is subject to the policy; and
executing the machine-code syntax tree to determine whether the transaction request is compliant with the policy.

4. The computer-implemented method of claim 1, wherein storing the plurality of machine-code subroutine objects comprises storing an action subroutine object, the action subroutine object defining a particular subroutine that includes one or more actions to be performed to complete the particular subroutine.

5. The computer-implemented method of claim 1, wherein storing the plurality of machine-code subroutine objects comprises storing a condition subroutine object, the condition subroutine object defining a particular subroutine that includes one or more conditions to be checked to complete the particular subroutine.

6. The computer-implemented method of claim 1, wherein receiving the definition of the policy comprises:
providing a list of candidate actions and/or conditions for a domain, each action or condition corresponding to a machine-code subroutine object that is stored;
receiving, from the domain, a selection of actions and/or conditions to define the policy, wherein a selected action or condition corresponds to a component of the policy, and wherein generating the machine-code syntax tree comprises:
selecting a set of machine-code subroutine objects that correspond to the selection of actions and/or conditions that define the policy.

7. The computer-implemented method of claim 1, wherein the machine-code syntax tree is a first machine-code syntax tree that is associated with a first policy of a first domain, and the computer-implemented method further comprises associating a second machine-code syntax tree with a second policy of a second domain that is different from the first domain.

8. The computer-implemented method of claim 7, wherein storing the plurality of machine-code subroutine objects is performed by a computing server that provides a software-as-a-service (SaaS) platform to a plurality of domain customers, and the first machine-code syntax tree and the second machine-code syntax tree that are associated with different domain customers share one or more machine-code subroutine objects that are stored by the computing server.

9. The computer-implemented method of claim 1, further comprising:
receiving a modification of the policy;
modifying the machine-code syntax tree, wherein modifying the machine-code syntax tree comprises inserting a machine-code subroutine object to the machine-code syntax tree or removing a machine-code subroutine object from the machine-code syntax tree; and
storing a modified machine-code syntax tree as a modified workflow that implemented the policy as modified.

10. The computer-implemented method of claim 1, further comprising executing the machine-code syntax tree, wherein executing the machine-code syntax tree comprises:
executing a first set of machine-code instructions to communicate to a named entity for an authorization request; and
executing a second set of machine-code instructions to compare a response of the authorization request to a condition defined in one of machine-code subroutine objects in the machine-code syntax tree.

11. The computing-implemented method of claim 1, wherein storing the plurality of machine-code subroutine objects comprises:
generating parameters and executable routines of a subroutine function in a source code format;
compiling the subroutine function into binary instructions as one of the machine-code subroutine objects; and
storing the one of the machine-code subroutine objects in a data store, wherein the one of the machine-code subroutine objects is available as a component of one or more policies.

12. A computer-implemented method comprising:
creating, on behalf of a domain and by an ontology management operator, a first data object that represents an account, wherein the domain delegates transaction authorization of one or more transactions of the domain to the ontology management operator;
providing a graphical user interface for the domain to define a domain specific policy that is part of a domain knowledge ontology of the domain;
storing the domain specific policy as a second data object;
receiving, from the domain, an assignment that assigns the domain specific policy to the account;
connecting, responsive to the domain assigning the domain specific policy to the account, the first data object and the second data object;
receiving an authorization request for a transaction associated with the account;
identifying, from the domain knowledge ontology of the domain, a chain of data objects that is relevant to completing the authorization request for the transaction, the chain of data objects comprises the first data and the second data object;
defining a workflow to authorize the transaction through traversing the chain of data objects;
identifying a violation in the transaction of a condition in the workflow, the violation preventing the workflow from being completed, the condition being defined in the domain specific policy;
identifying a third data object in the chain of data objects that is associated with the condition, the third data object representing a named entity; and
transmitting a notification to the named entity to add an adjustment, wherein the adjustment is added to the domain knowledge ontology that authorizes a future transaction that violates the condition.

13. The computer-implemented method of claim 12, wherein the second data object storing the domain specific policy is assigned to a plurality of accounts, and wherein the fourth data object is added to the chain of data objects that is specific to the account that is represented by the first data object without changing the second data object.

14. The computer-implemented method of claim 12, wherein one of the data objects in the chain of data objects represents one of the following: a named entity within the domain, a third party named entity, a domain department, a policy, a documentation, or a version.

15. The computer-implemented method of claim 12, wherein the domain specific policy governs a total amount combined from a type of real-time transaction and a type of non-real-time transaction.

16. The computer-implemented method of claim 12, wherein the chain of data objects comprises a post-transaction requirement and one or more features of the account is suspended if the post-transaction requirement is not met.

17. The computer-implemented method of claim 12, wherein the domain specific policy comprises a combination of one or more of following conditions: amount specific condition, merchant category code condition, employee level condition, or time condition.

18. The computer-implemented method of claim 12, wherein a particular data object in chain of data objects is linked to a third party platform and the particular data object specifies a second condition that automatically transmits data to the third party platform.

19. The computer-implemented method of claim 12, further comprising:
generating a recommendation to the account on seeking approval of the transaction.

20. The computer-implemented method of claim 19, wherein the recommendation is a second workflow that is presented to the account for the account to seek approval of the transaction.
